(19) United States
(12) Patent Application Publication
(10) Pub. No.: US 2017/0150421 A1
(43) Pub. Date: May 25, 2017

(54) COMMUNICATION CONTROL METHOD, TERMINAL DEVICE, SERVER DEVICE, AND COMMUNICATION SYSTEM

(71) Applicant: SHARP KABUSHIKI KAISHA, Sakai City, Osaka (JP)

(72) Inventors: Yoko KUGE, Sakai City (JP); Masafumi ARAMOTO, Sakai City (JP); Masayuki ENOMOTO, Sakai City (JP)

(73) Assignee: SHARP KABUSHIKI KAISHA, Sakai City, Osaka (JP)

(21) Appl. No.: 15/309,579

(22) PCT Filed: May 1, 2015
(86) PCT No.: PCT/JP2015/063130

§ 371 Date: Nov. 8, 2016

(30) Foreign Application Priority Data
May 9, 2014 (JP) 2014-097439

(51) Int. Cl. H04W 40/34; H04W 76/04

(52) U.S. Cl. CPC H04W 40/34; H04W 76/043

(57) ABSTRACT

A communication terminal device switches between direct communication using LTE and infrastructure communication via a core network while continuing a communication service.

A request message for instructing that a communication path is switched is transmitted from a server device to the communication terminal device, and thus, the switching from the direct communication using LTE to the infrastructure communication via the core network can be performed while the communication service is continued.

### TECHNICAL FIELD

The present invention relates to a communication control method, and a communication system including a terminal device and a server device.

### BACKGROUND ART

In the 3rd Generation Partnership Project (3GPP) that standardizes recent mobile communication systems, the specifications of an Evolved Packet System (EPS), which realize an all-IP network, have progressed. In the 3GPP, an access system connected to the EPS has also been examined in the case of a wireless LAN in addition to LTE.

The 3GPP has examined proximity-based services (ProSe) having a function (discovery) of detecting that UEs are present in proximity to each other or a function (direct communication) of establishing direct communication without passing through a core network or a base station in the specifications of the EPS between the UEs.

In ProSe, since communication is performed without using the core network to which the base station or the access network is connected, it is possible to avoid the concentration in the access network or the core network (congestion avoidance), and it is possible to expect an offloading effect.

In ProSe, a service that searches for and detects communication target UE of the direct communication is required to establish a direct communication path. In ProSe, two methods have been examined as the detection method. The first method is a method (hereinafter, referred to as “direct discovery”) in which the UE directly detects the communication target UE. The second method is a method (hereinafter, referred to as “EPC-level discovery”) in which the UE detects the communication target UE via the access network or the core network. However, a ProSe service is provided by a mobile communication operator, and needs to be approved by the mobile communication operator in order to use the ProSe service. Thus, in the 3GPP, it is necessary to provide a ProSe server as a functional unit that manages the ProSe service within the core network or a packet data network (PDN) under the management of the mobile communication operator in order to realize the ProSe service. That is, in the ProSe, the communication operator authenticates the establishment of a communication path of the direct communication, unlike tethering.

In ProSe, the use of two methods as the direct communication path between the UEs has been examined. The first method is a method of using an LTE access technology. The second method is a method of using a wireless LAN (WLAN) access technology.

In ProSe, non-public safety and public safety are defined. In the non-public safety, a commercial service provided by the mobile communication operator is assumed, and can be used only in a case where the UE is served by an LTE base station. Meanwhile, in the public safety, the use of a wireless disaster-prevention system is assumed, and can be used both in a case where the UE is served by the LTE base station and a case where the UE is not served by the LTE base station (eNB 52).

The 3GPP has suggested that it is necessary to examine a method of continuing a service between the direct communication of the ProSe and infrastructure communication using the network in the related art.

### CITATION LIST

### Non Patent Literature

NPL 1: 3GPP TS23.401 Technical Specification Group Services and System Aspects, General Packet Radio Service (GPRS) enhancements for Evolved Universal Terrestrial Radio Access Network (E-UTRAN) access
NPL 2: 3GPP TR23.703 Technical Specification Group Services and System Aspects, Study on architecture enhancements to support Proximity-based Services (ProSe)

### SUMMARY OF INVENTION

### Technical Problem

In the ProSe technology, the UE (terminal device) needs to be able to establish two types of communication paths including a communication path through which the direct communication with at least one UE is performed and a communication path through which communication through the infrastructure communication via the core network such as EPC is performed.

The two communication paths are switched depending on an internal factor and an external factor of the UE such as a change in environment or movement of the UE. The UE or the network needs to be able to determine the switching between the communication paths by detecting these factors.

A method of switching between two communication paths in the UE or the network is not apparent yet.

The present invention has been made in order to solve the above-described problems, and it is an object of the present invention to provide a terminal device with which a terminal device or a server device determines switching between communication paths of at least two or more terminal devices and performs the switching.

### Solution to Problem

There is provided a server device according to the present invention adapted to: transmit a first request message including first identification information to a second terminal device that performs direct communication using LTE with a first terminal device. The first identification information indicates a request for switching of communication between the terminal devices from the direct communication using LTE to infrastructure communication performed via a core network.

There is provided a server device according to the present invention adapted to transmit a first request message including first identification information to a second terminal device that performs direct communication using LTE with a first terminal device. The first identification information indicates a request for the switching of the communication between the terminal devices from the direct communication using LTE to the infrastructure communication performed via the core network and for transmission of a request message for the switching of the communication between the terminal devices from the direct communication using LTE to the infrastructure communication performed via the core network to a first communication terminal.

There is provided a server device according to the present invention adapted to: transmit a first request message including first identification information to a second terminal device that performs direct communication using LTE with a first terminal device, the first identification information indicating a request for switching of communication between the terminal devices from the direct communication using LTE to infrastructure communication performed via a core network; and transmit a second request message including second identification information to the first terminal device, the second identification information indicating the request for the switching of the communication between the terminal devices from the direct communication using LTE to the infrastructure communication performed via the core network.

The server device is adapted to receive a third request message which includes third identification information and is transmitted from the second terminal device, the third identification information indicates the request for the switching of the communication between the terminal devices from the direct communication using LTE to the infrastructure communication performed via the core network, and the server device is adapted to transmit the first request message and/or the second request message based on the reception of the third request message.

There is provided a second terminal device that performs direct communication using LTE with a first terminal device. The second terminal device is adapted to: receive a first request message including first identification information from a server device, the first identification information indicating a request for switching of communication between the terminal devices from direct communication using LTE to infrastructure communication performed via a core network; and switch from the direct communication using LTE to the infrastructure communication performed via the core network to continue the communication with the first terminal device, based on the reception of the first request message.

The terminal device is adapted to transmit a third request message including third identification information to the server device, the third identification information indicates the request for the switching of the communication between the terminal devices from the direct communication using LTE to the infrastructure communication performed via the core network, and the terminal device is adapted to receive the first request message as a response to the third request message.

The terminal device is adapted to transmit a second request message including second identification information to the first terminal device based on the reception of the first request message, and the second identification information indicates the request for the switching of the communication between the terminal devices from the direct communication using LTE to the infrastructure communication performed via the core network.

The terminal device is adapted to release a resource for the direct communication using LTE after the switching from the direct communication using LTE to the infrastructure communication performed via the core network is performed.

The terminal device is adapted to perform the infrastructure communication performed via the core network with the first terminal device by using an IP address used in the direct communication using LTE.

The terminal device is adapted to perform the infrastructure communication performed via the core network with the first terminal device by using a second IP address different from a first IP address used in the direct communication using LTE.

There is provided a communication control method in a server device. The communication control method includes: a step of transmitting a first request message including first identification information to a second terminal device that performs direct communication using LTE with a first terminal device. The first identification information indicates a request for switching of communication between the terminal devices from the direct communication using LTE to infrastructure communication performed via a core network.

There is provided a communication control method in a server device. The communication control method includes: a step of transmitting a first request message including first identification information to a second terminal device that performs direct communication using LTE with a first terminal device. The first identification information indicates a request for switching of communication between the terminal devices from the direct communication using LTE to infrastructure communication performed via a core network and for transmission of a request message for the switching of the communication between the terminal devices from the direct communication using LTE to the infrastructure communication performed via the core network to a first communication terminal.

There is provided a communication control method in a server device. The communication control method includes: a step of transmitting a first request message including first identification information to a second terminal device that performs direct communication using LTE with a first terminal device, the first identification information indicating a request for switching of communication between the terminal devices from the direct communication using LTE to infrastructure communication performed via a core network; and a step of transmitting a second request message including second identification information to the first terminal device, the second identification information indicating the request for the switching of the communication between the terminal devices from the direct communication using LTE to the infrastructure communication performed via the core network.

The communication control method further includes: a step of receiving a third request message which includes third identification information and is transmitted from the second terminal device, the third identification information indicating the request for the switching of the communication between the terminal devices from the direct communication using LTE to the infrastructure communication performed via the core network; and a step of transmitting the first request message and/or the second request message based on the reception of the third request message.

There is provided a communication control method of a second terminal device that performs direct communication using LTE with a first terminal device. The communication control method includes: a step of receiving a first request message including first identification information from a server device, the first identification information indicating a request for switching of communication between the terminal devices from direct communication using LTE to infrastructure communication performed via a core network; and a step of switching from the direct communication using LTE to the infrastructure communication performed via the core network to continue the communication with the first terminal device, based on the reception of the first request message.

The communication control method further includes: a step of transmitting a third request message including third identification information to the server device, the third identification information indicating the request for the switching of the communication between the terminal devices from the direct communication using LTE to the infrastructure communication performed via the core network; and a step of receiving the first request message as a response to the third request message.

The communication control method further includes: a step of transmitting a second request message including second identification information to the first terminal device based on the reception of the first request message. The second identification information indicates the request for the switching of the communication between the terminal devices from the direct communication using LTE to the infrastructure communication performed via the core network.

The communication control method further includes: a step of releasing a resource for the direct communication using LTE after the switching from the direct communication using LTE to the infrastructure communication performed via the core network is performed.

The communication control method further includes: a step of performing the infrastructure communication performed via the core network with the first terminal device by using an IP address used in the direct communication using LTE.

The communication control method further includes: a step of performing the infrastructure communication performed via the core network with the first terminal device by using a second IP address different from a first IP address used in the direct communication using LTE.

There is provided a communication system that includes a first terminal device and a second terminal device which perform direct communication using LTE, and a server device. The second terminal device transmits a first request message including first identification information to the server device, and the first identification information indicates a request for switching of communication between the terminal devices from the direct communication using LTE to infrastructure communication performed via a core network. The server device receives the first request message which includes the first identification information and is transmitted from the second terminal device, and the first identification information indicates the request for the switching of the communication between the terminal devices from the direct communication using LTE to the infrastructure communication performed via the core network. The server device transmits a second request message including second identification information to the second terminal device based on the reception of the first request message, and the second identification information indicates the request for the switching of the communication between the terminal devices from the direct communication using LTE to the infrastructure communication performed via the core network. The second terminal device receives the second request message including the second identification information from the server device, and the second identification information indicates the request for the switching of the communication between the terminal devices from the direct communication using LTE to the infrastructure communication performed via the core network. The second terminal device switches from the direct communication using LTE to the infrastructure communication performed via the core network to continue the communication with the first terminal device, based on the reception of the second request message.

### Advantageous Effects of Invention

According to the present invention, the server device or the terminal device can mainly switch between infrastructure communication via a network such as EPC and direct communication. Therefore, it is possible to continue a service.

### BRIEF DESCRIPTION OF DRAWINGS

FIG. 1 is a schematic diagram for describing a mobile communication system.

FIG. 2 is a diagram for describing a structure of an IP mobile communication network.

FIG. 3 is a diagram for describing a functional structure of UE.

FIG. 4 is a diagram showing an example of each data structure stored in a storage unit.

FIG. 5 is a diagram for describing a functional structure of a ProSe server.

FIG. 6 is a diagram showing an example of each data structure stored in a storage unit.

FIG. 7 is a diagram for describing an operation outline according to a first embodiment.

FIG. 8 is a diagram for describing an outline of communication according to the first embodiment.

FIG. 9 is a diagram for describing an outline of a packet according to the first embodiment.

FIG. 10 is a diagram for describing a service authentication procedure.

FIG. 11 is a diagram for describing a processing example according to the first embodiment.

FIG. 12 is a diagram for describing trigger detection and IP address assignment according to the first embodiment.

FIG. 13 is a diagram showing a flow of transmitting a request message of the UE according to the first embodiment.

FIG. 14 is a diagram showing a flow of updating path information of the UE according to the first embodiment.

FIG. 15 is a diagram showing a flow of updating path information of the ProSe server according to the first embodiment.

FIG. 16 is a diagram for describing a processing example according to a second embodiment.

FIG. 17 is a diagram showing a flow of updating the path information of the UE according to the second embodiment.

FIG. 18 is a diagram showing a flow of updating the path information of the ProSe server according to the second embodiment.

FIG. 19 is a diagram for describing an operation outline according to a third embodiment.

FIG. 20 is a diagram for describing a processing example according to the third embodiment.

FIG. 21 is a diagram showing a flow of updating the path information of the UE according to the third embodiment.

FIG. 22 is a diagram showing a flow of updating the path information of the ProSe server according to the third embodiment.

FIG. 23 is a diagram for describing a processing example according to a fourth embodiment.

FIG. 24 is a diagram showing a flow of updating the path information of the UE according to the fourth embodiment.

FIG. 25 is a diagram showing a flow of updating the path information of the ProSe server according to the fourth embodiment.

FIG. 26 is a diagram for describing a processing example according to a fifth embodiment.

FIG. 27 is a diagram showing a flow of updating the path information of the UE according to the fifth embodiment.

FIG. 28 is a diagram showing a flow of updating the path information of the ProSe server according to the fifth embodiment.

FIG. 29 is a diagram for describing a processing example according to a sixth embodiment.

FIG. 30 is a diagram showing a flow of updating the path information of the UE according to the sixth embodiment.

FIG. 31 is a diagram showing a flow of updating the path information of the ProSe server according to the sixth embodiment.

### DESCRIPTION OF EMBODIMENTS

Hereinafter, preferred embodiments for implementing the present invention will be described with reference to the drawings. As an example in the present embodiment, an embodiment of a mobile communication system in a case where the present invention is applied will be described.

### 1. First Embodiment

Hereinafter, a wireless communication technology according to an embodiment of the present invention will be described in detail with reference to the drawings.

[1.1 Outline of Communication System]

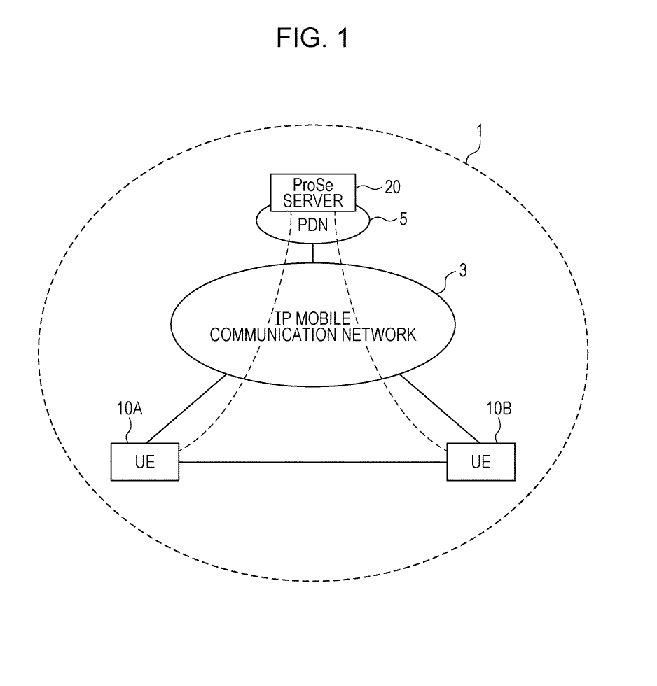

FIG. 1 is a functional block diagram showing a schematic structure example of a wireless communication system according to the embodiment of the present invention.

A wireless communication system 1 shown in FIG. 1 is a network that includes a packet data network (PDN) 5, and an IP mobile communication network 3. A ProSe server 20 is connected to the PDN 5, and a UE (a mobile station apparatus or a terminal device) 10 is connected to the IP mobile communication network 3.

The UE 10 according to the present embodiment is UE (ProSe-enabled UE) having a ProSe function, and UEs 10A and 10B are connected in the present embodiment.

Here, the PDN 5 and the respective UEs 10 (the UE 10A and the UE 10B) are connected via the IP mobile communication network 3. As in the example shown in FIG. 1, the UE 10A and the UE 10B may establish a communication path for direct communication of ProSe. The UE 10A may establish a communication path for direct communication of ProSe with UE having a ProSe function other than the UE 10B. Similarly, the UE 10B may establish a communication path for direct communication with UE having a ProSe function other than the UE 10A.

The ProSe server 20 is an authentication server that manages communication associated with the ProSe services of the UE 10A and the UE 10B. The ProSe server 20 is included in the PDN 5 in FIG. 1, but may be independent of the PDN 5.

Here, the respective UEs 10 may be connected to the same mobile communication operator network, may be connected to different mobile communication operator networks, or may be a broadband network operated by a fixed communication operator.

The broadband network is an IP communication network which is operated by a communication operator that is connected through asymmetric digital subscriber line (ADSL) to provide high-speed communication through a digital line such as an optical fiber. The broadband network is not limited to the above-described example, and may be a network that is wirelessly accessed through worldwide interoperability for microwave access (WiMAX).

Each UE 10 such as the UE 10A or the UE 10B is a communication terminal that is connected using an access system such as LTE or WLAN, and may be accessed to an IP access network through connection by including 3GPP LTE communication interface or WLAN communication interface.

The PDN 5 is a network that provides network services for performing transmission and reception of data in packets, and is, for example, a service network that provides a specific service such as a service based on the Internet or IMS.

The PDN 5 is connected to the IP access network by using a wired line. For example, the PDN is established using the ADSL or the optical fiber. However, the PDN is not limited to the above-described example, and may be a radio access network such as LTE, WLAN or worldwide interoperability for microwave access (WiMAX).

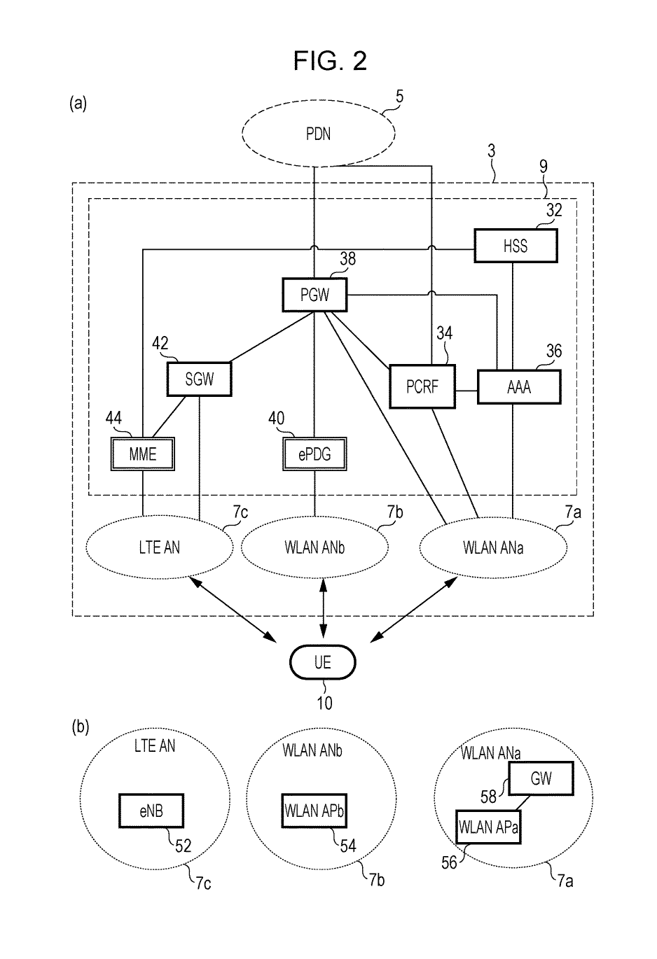

FIG. 2 is a detailed structure example of the wireless communication system 1 shown in FIG. 1. The structure example of the system shown in FIG. 2 includes the UE 10 (UE 10A or UE 10B), the IP mobile communication network 3, and the PDN 5. In addition to the UEs 10 (the UE 10A and the UE 10B) described in the present specification, a plurality of UEs may be connected to the IP mobile communication network 3.

The IP mobile communication network 3 includes a core network 9, and radio access networks (for example, LTE AN 7c, WLAN ANb 7b, and WLAN ANa 7a). The core network 9 includes a home subscriber server (HSS) 32, Authentication, Authorization and Accounting (AAA) 36, a policy and charging rules function (PCRF) 34, a packet data network gateway (PGW) 38, an enhanced packet data gateway (ePDG) 40, a serving gateway (SGW) 42, and a mobile management entity (MME) 44.

The radio access network may include a plurality of different access networks. The access networks are connected to the core network 9. Each UE 10 may be wirelessly connected to the radio access network.

The radio access network may include the LTE access network (LTE AN 7c) capable of being connected by an LTE access system, and the access networks (WLAN ANa 7a and WLAN ANb 7b) capable of being connected by a WLAN access system.

The access network capable of being connected by the WLAN access system may include the WLAN access network b (WLAN ANb 7b) that is connected using the ePDG 40 as a connection apparatus to the core network 9, and the WLAN access network a (WLAN ANa 7a) that is connected to the PGW 38, the PCRF 34 and the AAA 36.

Since the apparatuses within the IP mobile communication network 3 have the same structure as that of the apparatus of the related art in the mobile communication system using EPS, the detailed description will be omitted. Hereinafter, the respective apparatuses may be simply described.

The PGW 38 is connected to the PDN 5, the SGW 42, the ePDG 40, the WLAN ANa 7a, the PCRF 34, and the AAA 36, and serves as a gateway apparatus between the PDN 5 and the core network 9 to deliver user data.

The SGW 42 is connected to the PGW 38, the MME 44, and the LTE AN 7c, and serves as a gateway apparatus between the core network 9 and the LTE AN 7c to deliver user data.

The MME 44 is connected to the SGW 42, the LTE AN 7c, and the HSS 32, and is an access control apparatus that performs access control of the UE 10 via the LTE AN 7c.

The HSS 32 is connected to the MME 44 and the AAA 36, and is a management node that manages subscriber information. For example, the subscriber information of the HSS 32 is referred to when access control of the MME 44 is performed.

The AAA 36 is connected to the PGW 38, the HSS 32, the PCRF 34, and the WLAN ANa 7a, and performs the access control of the UE 10 that is connected via the WLAN ANa 7a.

The PCRF 34 is connected to the PGW 38, the WLAN ANa 7a, the AAA 36 and the PDN 5, and performs QoS management for data delivery.

The ePDG 40 is connected to the PGW 38 and the WLAN ANb 7b, and serves as a gateway apparatus between the core network 9 and the WLAN ANb 7b to deliver user data.

As shown in FIG. 2(b), an apparatus (for example, a base station apparatus or an access point apparatus) to which the UE 10 is actually connected is included in each radio access network. As the apparatus used in the connection, an apparatus adapted to the radio access network is considered.

In the present embodiment, the LTE AN 7c includes an eNB 52. The eNB 52 is a radio base station to which the UE 10 is connected by the LTE access system, and the LTE AN 7c may include one or a plurality of radio base stations.

The WLAN ANa 7a includes a WLAN APa 56, and a gateway (GW) 58. The WLAN APa 56 is a radio base station to which the UE 10 is connected by the WLAN access system having reliability against an operator that operates the core network 9, and the WLAN ANa 7a may include one or a plurality of radio base stations. The GW 58 is a gateway apparatus between the core network 9 and the WLAN ANa 7a. The WLAN APa 56 and the GW 58 may be realized as a single apparatus.

Even though an operator that operates the core network 9 and an operator that operates the WLAN ANa 7a are different, such a structure may be realized by a contract or an agreement between the operators.

The WLAN ANb 7b includes a WLAN APb 54. In a case where there is no trusting relationship with the operator that operates the core network 9, the WLAN APb 54 is a radio base station to which the UE 10 is connected by the WLAN access system, and the WLAN ANb 7b may include one or a plurality of radio base stations.

As stated above, the WLAN ANb 7b is connected to the core network 9 by using the ePDG 40 which is an apparatus included in the core network 9, as a gateway. The ePDG 40 has a security function for ensuring safety.

In the present specification, a case where the UE 10 is connected to each radio access network is a case where this UE is connected to a base station apparatus or an access point included in each radio access network, and data or a signal is also transmitted or received via the base station apparatus or the access point.

[1.2 Structures of Devices]

Hereinafter, a functional structure of each device according to the present embodiment will be described. Here, the UE 10A, the UE 10B and the ProSe server 20 of FIG. 1 will be described.

[1.2.1 Structure of UE]

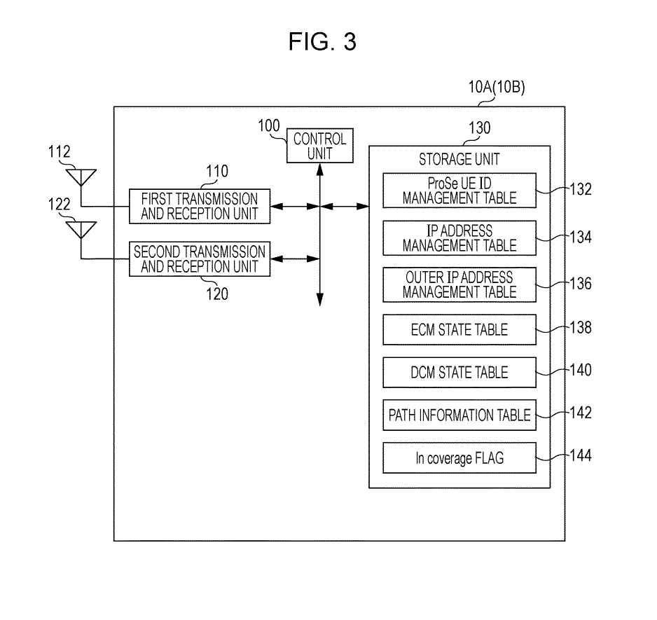

Initially, the structure of the UE 10A will be described with reference to FIG. 3. The functional structure of the UE 10B is realized using the same functional structure as the functional structure of the UE 10A, and thus, the description thereof will be omitted. The UE 10A may be a wireless terminal having the ProSe function, may be a mobile phone terminal that transmits and receives data through wireless communication by an LTE access method, or may be a terminal device that mutually exchanges information in the form of the so-called machine to machine.

The UE 10A includes a control unit 100, a first transmission and reception unit 110 to which a transmit and receive antenna 112 is connected, a second transmission and reception unit 120 to which a transmit and receive antenna 122 is connected, and a storage unit 130.

The control unit 100 is a functional unit for controlling the UE 10A. The control unit 100 is a functional unit which reads various programs stored in the storage unit 130 and executes the read program. For example, the control unit is a CPU.

The first transmission and reception unit 110 and the second transmission and reception unit 120 are functional units for performing wireless communication with an external terminal device or base station apparatus. For example, the transmission and reception unit is a functional unit that transmits and receives wireless communication data by the LTE access method.

The first transmission and reception unit 110 includes a transmission unit and a reception unit. The transmission unit may transmit control information via an LTE base station, and the reception unit may transmit data or control information via the LTE base station.

The second transmission and reception unit 120 is a functional unit capable of directly communicating with another UE using data or control information without using the LTE base station. The second transmission and reception unit 120 includes a transmission unit and a reception unit. The transmission unit may transmit data or control information without passing through the LTE base station. For example, the transmission and reception unit may perform transmission and reception using a direct communication path through LTE established between the UEs.

The functional units for transmission and reception may be switched by providing switches between the first transmission and reception unit 110 and the second transmission and reception unit 120 and the transmit and receive antenna, and the respective transmission and reception operations using the first transmission and reception unit 110 and the second transmission and reception unit 120 may be simultaneously performed. The first transmission and reception unit 110 and the second transmission and reception unit may be realized as one transmission and reception unit.

The storage unit 130 is a functional unit that stores data or program required in each operation of the UE 10A. For example, the storage unit 130 includes a semiconductor memory or a hard disk drive (HDD).

The storage unit 130 includes a ProSe UE ID management table 132, an IP address management table 134, an outer IP address management table 136, an EPS connection management (ECM) state table 138, a direct connection management (DCM) state table 140, a path information table 142, and an In coverage flag 144.

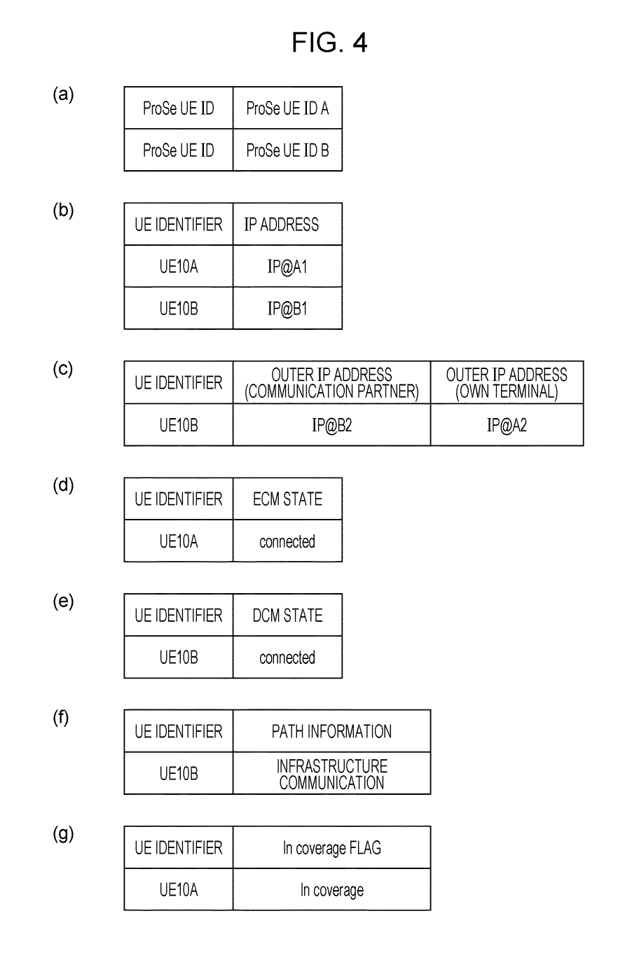

FIG. 4 shows an example of each information element stored in the storage unit 130. Hereinafter, the information element will be described with reference to FIG. 4.

FIG. 4(a) shows an example of the ProSe UE ID management table 132 stored in the storage unit 130 of the UE 10A. The UE 10A may store the ProSe UE ID corresponding to each UE in the ProSe UE ID management table 132. In FIG. 4(a), a ProSe UE ID (for example, “ProSe UE ID A”) corresponding to the UE 10A or a ProSe UE ID (for example, “ProSe UE ID B”) corresponding to the UE 10B which is a communication partner are managed.

The ProSe UE ID may be identification information for identifying the UE, may be identification information for identifying an application, or may be identification information indicating that the ProSe server 20 authenticates the UE.

The ProSe UE ID may be a link layer ID assigned by the EPS. Specifically, the ProSe UE ID may be a Layer 2 address used as a transmission source address when each UE performs the transmission and reception of data.

As stated above, the UE 10 may store a plurality of ProSe UE IDs, and may store an identifier “ProSe UE ID A” of the own terminal (UE 10A) or an identifier of another UE such as an identifier “ProSe UE ID B” of the communication partner (UE 10B).

The ProSe UE ID may include information for identifying an application, or information for identifying a communication operation or a country in addition to the information for identifying the UEs 10 (the UE 10A and the UE 10B).

The ProSe UE ID may further include information for identifying an application or information for identifying a communication operator or a country in addition to information for identifying the UE.

The IP address management table 134 is a table for managing an IP address. For example, the UE identifier and the IP address are managed and stored in association with each other. Here, the UE identifier may be the ProSe UE ID, may be subscriber information such as IMSI, or may be information for identifying another UE.

Here, an example of a data structure of the IP address management table 134 is shown in FIG. 4(b). In the IP address management table 134, when the UE is attached to the core network, an IP address (for example, “IP@A1”) acquired by the UE 10A from the core network and an IP address (for example, “IP@B1”) acquired by the UE 10B from the core network are stored.

The outer IP address management table 136 stores the UE identifier and an outer IP address so as to associate this identifier with this address. The UE identifier may be the ProSe UE ID, may be subscriber information such as IMSI, may be an IP address stored in the IP address management table 134, or may be information for identifying another UE.

Here, an example of a data structure of the outer IP address management table 136 is shown in FIG. 4(c). FIG. 4(c) shows an example of the outer IP address management table 136 for the UE that establishes the direct communication path, which is stored in the storage unit 130 of the UE 10A. As in the present example, for the direct communication between the UE 10A and the UE 10B which establish the direct communication path, an outer IP address (for example, “IP@B2”) of the UE 10B as the communication partner and an outer IP address (for example, “IP@A2”) of the UE 10A as the own terminal used in the communication are managed.

The ECM state table 138 is a table that manages a state of EPS connection management (ECM) of the own terminal (UE 10A). In the ECM state table 138, a radio resource may be allocated between the UE 10A and the eNB 52, and a “connected” mode in which a wireless communication path is established and an “idle” mode in which the resource of the wireless communication path with the base station is released due to no transmission and reception of data may be managed.

Here, an example of a data structure of the ECM state table 138 is shown in FIG. 4(d). In the example of FIG. 4(d), the UE 10A may be stored as being in the “connected” mode.

The DCM state table 140 is a table that manages a state of direct connection management (DCM) of the UE 10A in the relationship with each terminal device. That is, the DCM state is managed for each another UE.

Here, an example of a data structure of the DCM state table 140 is shown in FIG. 4(e). Here, in the DCM state table 140, a resource of a communication path for direct communication may be allocated, and a “connected” mode in which a wireless communication path is established and an “idle” mode in which a resource of a communication path for direct communication is released due to no transmission and reception of data may be managed.

In the case of FIG. 4(e), the DCM state is stored for the UE 10B capable of performing the direct communication.

The path information table 142 is a table that stores path information acquired by associating the communication partner with the communication path. In the path information table 142, path information such as “direct communication” or “infrastructure communication” is associated with each UE. In addition, as the path information, “UE-to-Network Relay” in which relay communication is performed by using another UE as a relay terminal may be stored.

In the path information table 142, the path information may be information for identifying a communication type such as “direct communication” or “infrastructure communication”, or may be information for identifying a communication path established by each communication type.

The UE may retain an address for each communication path, and the path information may be address information used in each communication path. The address information may be a Layer 2 address, or may be an IP address. The Layer 2 address of the path information for “direct communication” may be the ProSe UE ID.

An example of a data structure of the path information table 142 will be described with reference to FIG. 4(f). In FIG. 4(f), the UE 10A is stored as communicating with the UE 10B through the infrastructure communication.

In the In coverage flag 144 is a region in which the In coverage flag of the own terminal is stored.

Here, as for the In coverage flag 144, a case where the UE 10A is in a state (In coverage) in which this UE is present within the coverage of network access is illustrated in the example of FIG. 4(g). The coverage of the network access refers to an area constituting the eNB 52 as the LTE base station.

[1.2.2 Structure of ProSe Server 20]

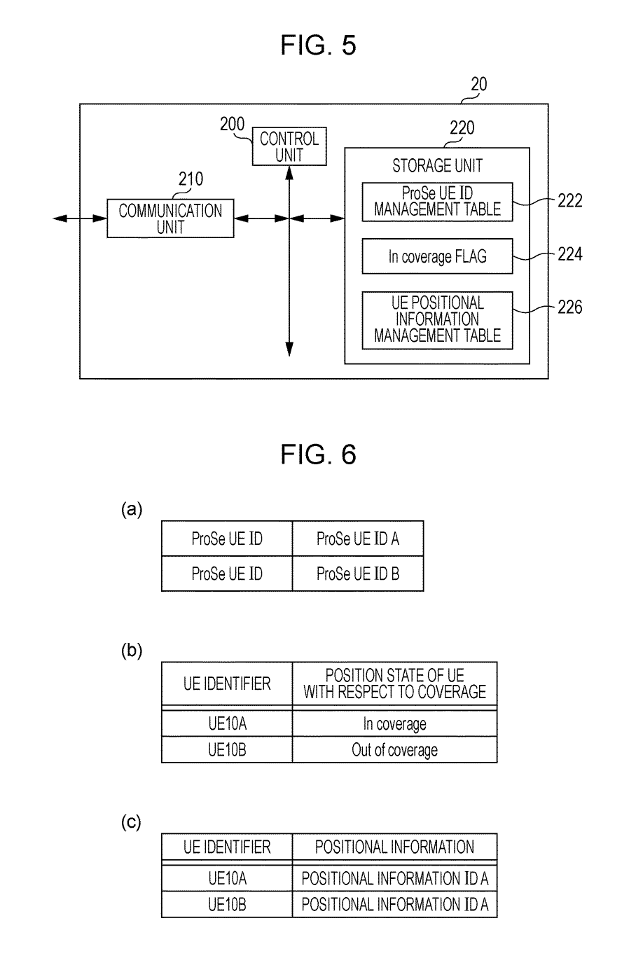

A functional structure of the ProSe server 20 according to the present embodiment will be described with reference to FIG. 5. The ProSe server 20 is an authentication server which performs proximity detection through ProSe and communication through ProSe and is managed by the mobile communication operator.

The ProSe server 20 includes a control unit 200, a communication unit 210, and a storage unit 220.

The control unit 200 is a functional unit for controlling the ProSe server 20. The control unit 200 is a functional unit which reads various programs stored in the storage unit 220 and executes the read program.

The communication unit 210 is a functional unit for allowing the ProSe server 20 to perform communication. In the present embodiment, the communication unit is an IP mobile communication network interface for allowing the ProSe server to be connected to the IP mobile communication network 3.

The storage unit 220 is a functional unit for storing data or program required in various operations of the ProSe server 20. For example, the storage unit 220 includes a semiconductor memory or a hard disk drive (HDD).

The storage unit 220 stores a ProSe UE ID management table 222, an In coverage flag 224, and a UE positional information management table 226.

FIG. 6 shows an example of each information element stored in the storage unit 220. Here, the stored content is different for each terminal, but the contents of the ProSe UE ID management table 222 and the In coverage flag 224 are the same as those of the tables described in the UE 10A.

That is, the ProSe UE ID management table 222 shown in FIG. 6(a) is the same as the ProSe UE ID management table 132 and the In coverage flag 224 shown in FIG. 6(b) is the same as the In coverage flag 144, and thus, the detailed description thereof will be omitted.

For example, the ProSe UE ID management table 222 shown in FIG. 6(a) stores the identifier (for example, “ProSe UE ID A”) of the UE 10A and the identifier (for example, “ProSe UE ID B”) of the UE 10B which are registered as the UEs having the ProSe function in the ProSe server 20, and the In coverage flag 224 shown in FIG. 6(b) stores the In coverage flags of the UE 10A and the UE 10B registered as the UEs having the ProSe function in the ProSe server 20.

The UE positional information management table 226 is a table that manages the positional information items of the UE 10A and the UE 10B which are registered as the UEs capable of using ProSe in the ProSe server 20. In the example shown in FIG. 6(c), the positional information items of the UE 10A and the UE 10B are “positional information ID A”, and thus, the ProSe server 20 can detect that the UE 10A and the UE 10B are present in proximity to each other.

The positional information ID may be an ID with which the positional information of each UE 10 (UE 10A, UE 10B or UE 10C) registered as the UE having the ProSe function in the ProSe server 20 can be ascertained, may be an eNB ID for identifying the base station, a tracking area ID (TAI) or a cell ID, or may be measurement information using GPS.

[1.3 Description of Process]

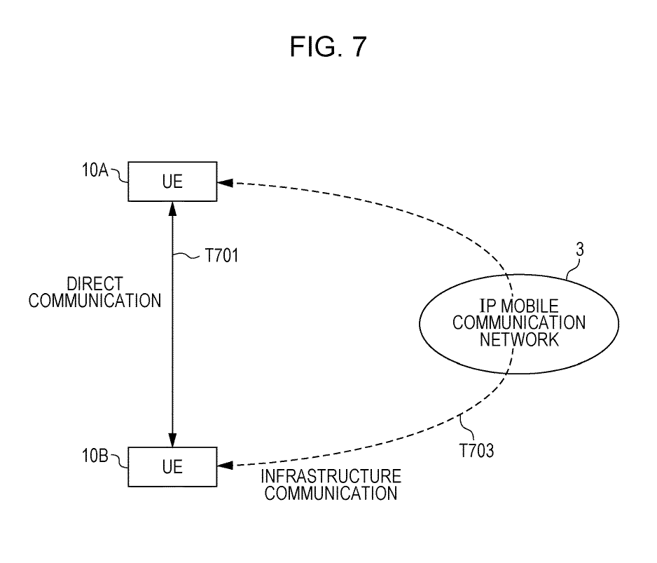

Hereinafter, the outline of the process described in the present embodiment will be described. FIG. 7 is a conceptual diagram showing that switching of the communication path and selection of the communication path performed in the present embodiment.

[1.3.1 Outline]

In an initial state of the present embodiment, the UE 10A and the UE 10B perform communication using a communication path depicted as direct communication T701 (solid line) of ProSe.

Any trigger occurs in the UE or the network, and thus, switching from the initial state to infrastructure communication T703 (dashed line) is performed. The infrastructure communication 703 is communication via the network such as EPC. The infrastructure communication means that the UE establishes PDN connection with the PGW and performs communication by using this PDN connection. The core network selects the PGW connected to the PDN when the PDN connection is established.

In the Present embodiment, the UE 10A switches the communication path between the UE 10B and the UE 10A from the direct communication T701 to the infrastructure communication T703 while continuing the service. When the communication path is switched, the UE 10A selects the communication path.

[1.3.2 Data Transmission and Reception Through IP Header Encapsulation]

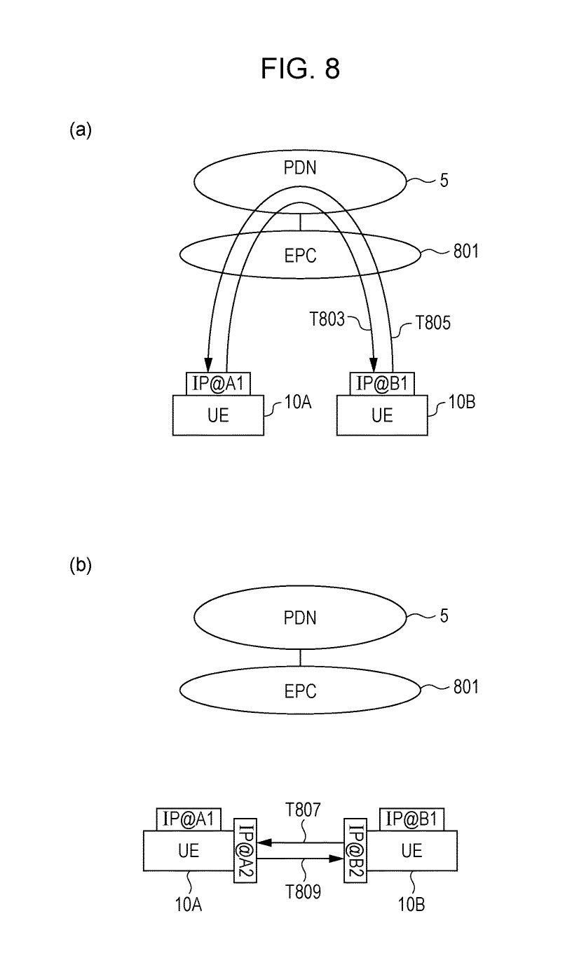

FIG. 8(a) is a diagram for describing the details of the infrastructure communication T703, and is a diagram showing the infrastructure communication between the UE 10A and the UE 10B. The UE 10A transmits data to the UE 10B through the infrastructure communication by using a communication path T803. That is, the UE 10B receives the data from the UE 10A through the infrastructure communication by using the communication path T803.

The UE 10B transmits data to the UE 10A through the infrastructure communication by using a communication path T805. That is, the UE 10A receives the data from the UE 10B through the infrastructure communication by using the communication path T805.

The UE 10A acquires the IP address “IP@A1” from the core network 9 when an initial attach procedure is performed. The core network 9 assigns the “IP@A1” to the UE 10A, and notifies the UE 10A of the assigned IP address.

Similarly, the UE 10B acquires the IP address “IP@B1” from the core network 9 when an initial attach procedure is performed. The core network 9 assigns the “IP@B1” to the UE 10B, and notifies the UE 10B of the assigned IP address.

FIG. 8(b) is a diagram for describing the details of the direct communication T701 of ProSe, and is a diagram showing direct communication between the UE 10A and the UE 10B.

The UE 10A transmits data to the UE 10B through the direct communication by using a communication path T809. The UE 10B receives the data from the UE 10A through the direct communication by using the communication path T809.

The UE 10B transmits data to the UE 10A through the direct communication by using a communication path T809. The UE 10A receives the data from the UE 10B through the direct communication by using the communication path T809.

The UE 10A and the UE 10B store the IP address “IP@A2” and the IP address “IP@B2” for direct communication which are assigned by the UE 10A and the UE 10B and are used in the direct communication, as the outer IP addresses. These UEs encapsulate IP headers with the outer IP addresses as a transmission source address and a transmission destination address, and perform the direct communication. Accordingly, the service is continued before and after the communication path is switched. A specific structure example of a transmission and reception packet will be described in the subsequent chapter.

Although the UE 10A and the UE 10B are attached to the network through the same EPC 801 in FIGS. 8(a) and 8(b), these UEs may be attached to the network through different EPCs.

[1.3.3 Description of IP Packet]

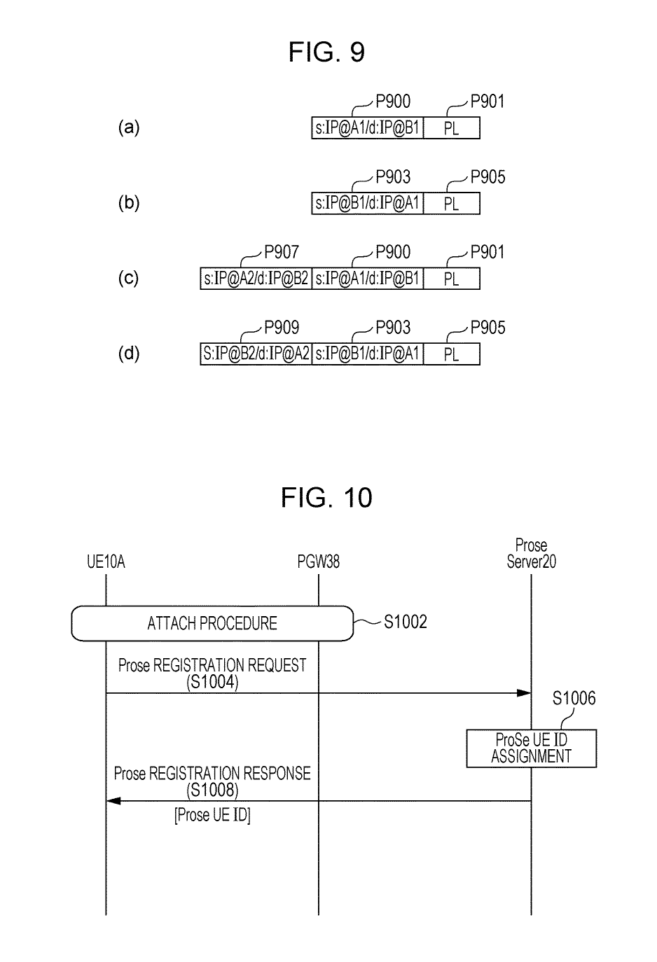

Hereinafter, a method of encapsulating the IP packet, which is likely to be used in the present embodiment will be described with reference to FIG. 9.

(a) UE 10A→UE 10B

FIG. 9(a) shows an example of the IP packet transmitted by the UE 10A to the UE 10B through the infrastructure communication shown in FIG. 8(a) by using the communication path T803. That is, an example of the IP packet receives by the UE 10B from the UE 10A through the infrastructure communication by using the communication path T803 is shown. The IP packet of FIG. 9(a) includes the information items of the IP address (for example, “IP@A1”) of the UE 10A which is the transmission source of this IP packet and the IP address (for example, “IP@B1”) of the UE 10B which is the transmission destination thereof, and thus, the IP packet includes an IP header P900 indicating that this IP packet is transmitted from the UE 10A to the UE 10B and a payload (PL) P901.

Here, the payload is data which is originally transmitted except for the header part, and the payload part includes user data which is application data.

(b) UE 10B→UE 10A

FIG. 9(b) shows an example of the IP packet transmitted by the UE 10B to the UE 10A through the infrastructure communication shown in FIG. 8(a) by using the communication path T805. That is, an example of the IP packet received by the UE 10A from the UE 10B through the infrastructure communication by using the communication path T805 is shown. The IP packet of FIG. 9(b) includes the information items of the IP address (for example, “IP@B1”) of the UE 10B which is the transmission source of this IP packet and the IP address (for example, “IP@A1”) of the UE 10A which is the transmission destination thereof, and thus, the IP packet includes an IP header P903 indicating that this IP packet is transmitted from the UE 10B to the UE 10A and a payload (PL) P905.

(c) UE 10A→UE 10B

FIG. 9(c) shows an example of the IP packet transmitted by the UE 10A to the UE 10B through the direct communication shown in FIG. 8(b) by using the direct communication path T807. That is, an example of the IP packet received by the UE 10B from the UE 10A through the direct communication by using the communication path T807 is shown. The IP packet of FIG. 9(c) includes the information items of the outer IP address (for example, “IP@A2”) of the UE 10A as the transmission source and the outer IP address (for example, “IP@B2”) of the UE 10B as the transmission destination and includes an outer IP header P907 indicating that this IP packet is an IP packet transmitted from the UE 10A to the UE 10B through the direct communication and the information items of the IP address (for example, “IP@A1”) of the UE 10A as the transmission source and the IP address (for example, “IP@B1”) of the UE 10B as the transmission destination, and thus, the IP packet includes an IP header P900 indicating that this IP packet is transmitted from the UE 10A to the UE 10B and a payload (PL) P901.

That is, the IP packet of FIG. 9(c) is acquired by adding the outer IP header P907 to the IP packet of FIG. 9(a). In other words, the IP packet includes the outer IP header as the header part and the IP packet transmitted and received in the infrastructure communication.

(d) UE 10B→UE 10A

FIG. 9(d) shows an example of the IP packet transmitted by the UE 10B to the UE 10A through the direct communication shown in FIG. 8(b) by using the direct communication path T809. That is, an example of the IP packet received by the UE 10A from the UE 10B through the direct communication by using the communication path T809 is shown. The IP packet of FIG. 9(d) includes the information items of the outer IP address (for example, “IP@B2”) of the UE 10B as the transmission source and the outer IP address (for example, “IP@A2”) of the UE 10A as the transmission destination and includes an outer IP header P909 indicating that this IP packet is an IP packet transmitted from the UE 10B to the UE 10A through the direct communication and the information items of the IP address (for example, “IP@B1”) of the UE 10B as the transmission source and the IP address (for example, “IP@A1”) of the UE 10A as the transmission destination, and thus, the IP packet includes an IP header P903 indicating that this IP packet is transmitted from the UE 10B to the UE 10A and a payload (PL) P905.

That is, the IP packet of FIG. 9(d) is acquired by adding the outer IP header P909 to the IP packet of FIG. 9(b). In other words, the IP packet includes the outer IP header as the header part and the IP packet transmitted and received in the infrastructure communication.

As described above, the UE 10A can perform the infrastructure communication with the UE 10B performed via the core network by using the IP address used in the direct communication using LTE. That is, the communication control method of the UE 10A may include a step of performing the infrastructure communication performed with the UE 10B via the core network by using the IP address used in the direct communication using LTE.

Similarly, the UE 10B can also perform the infrastructure communication with the UE 10A performed via the core network by using the IP address used in the direct communication using LTE.

Although it has been described in this example by referring to FIG. 8 that the service is continued by using the same IP address in the direct communication using LTE by encapsulating the IP header in the IP address used in the infrastructure communication via the core network, the service continuing method is not limited thereto. For example, the UE 10A may perform the infrastructure communication with the UE 10B via the core network by using an IP address different from the IP address used in the direct communication using LTE. The same is true of the UE 10B. That is, the communication control method of the UE 10A may further include a step of causing the UE 10A to perform the infrastructure communication with the UE 10B via the core network by using an IP address different from the IP address used in the direct communication using LTE.

[1.4 Processing Example]

Hereinafter, the process according to the present embodiment will be described with the following drawings. A sequence diagram and an operation flow described in the present embodiment are merely examples, and even though the process order is changed without influencing the operation, the realization of the present invention is not influenced.

[1.4.1 ProSe Registration]

In the present embodiment, in order for the ProSe server 20 to perform the service authentication on each UE, the ProSe server 20 needs to register each UE 10 (UE 10A or UE 10B) as the UE having the ProSe function and manage each UE. When each UE 10 (UE 10A or UE 10B) is registered in the ProSe server 20, the core network 9 needs to assign the ProSe UE ID to each UE 10. The ProSe UE ID mentioned herein may include at least authentication information indicating that the ProSe server 20 authenticates the UE.

FIG. 10 shows an example of the process until the UE 10A acquires the ProSe UE Id from the ProSe server 20 after this UE is registered as the ProSe-enabled UE in the ProSe server 20. The procedure in which the UE 10B is registered as the ProSe-enabled UE in the ProSe server 20 and acquires the ProSe UE ID from the ProSe server 20 is performed using the same procedure as the procedure in the UE 10A, and thus, the description thereof will be omitted.

The UE 10A performs an attach procedure (S1002). More specifically, the UE 10A transmits an attach request message to the MME 44 and starts the attach procedure, and the UE 10A establishes the PDN connection which is the communication path used in the infrastructure communication with the PGW 38 selected by the MME 44 based on the attach request message. The UE 10A acquires the IP address used in the infrastructure communication from the core network 9. In contrast, the core network 9 assigns the IP address to the UE 10A based on the attach request message transmitted from the UE 10A.

The method of acquiring the IP address in the UE 10A is not limited to the attach procedure, and another method may be used. For example, after the attach procedure is performed, the UE may acquire the IP address by performing a PDN connectivity procedure for establishing the PDN connection. More specifically, the UE 10A transmits a PDN connectivity request message to the MME 44 and starts the PDN connectivity procedure, and the UE 10A establishes the PDN connection which is the communication path used in the infrastructure communication with the PGW 38 selected by the MME 44 based on the PDN connectivity request message. The UE 10A acquires the IP address used in the infrastructure communication from the core network 9. In contrast, the core network 9 assigns the IP address to the UE 10A based on the PDN connectivity request message transmitted from the UE 10A.

As mentioned above, the UE may perform the infrastructure communication related to the ProSe service by using the IP address different from the IP address acquired in the attach procedure.

The attach request message or the PDN connectivity request message including identification information indicating that the acquisition of an IP address capable of communicating with UE of a different operator is requested may be transmitted. The core network may assign an IP address capable of being routed to another operator based on such identification information. In a case where such identification information is not included, the core network may assign an IP address capable of being routed to only within an operator network. As a more specific method, the assignment of the IP address may be performed by the MME 40, or may be performed by the PGW 38.

If the initial procedure of S1002 is completed, the UE 10A transmits a registration request as the ProSe-enabled UE to the ProSe server 20 (S1004). If the ProSe registration request is received from the UE 10A, the ProSe server 20 assigns the ProSe UE ID to the UE 10A (S1006).

The ProSe server 20 transmits a ProSe registration response including the ProSe UE ID (ProSe UE ID A) assigned to the UE 10A to the UE 10A (S1008).

The UE 10A receives the ProSe registration response from the ProSe server 20, and acquires the ProSe UE ID (ProSe UE ID A) assigned to the UE 10A. If the ProSe UE ID is acquired, the UE 10A may store the acquired ProSe UE ID in the ProSe UE ID management table 332 within the storage unit 330.

Here, the registration request transmitted from the UE 10A to the ProSe server 20 may be to request that the reception of the service associated with ProSe is authenticated. The ProSe server 20 may check that the service can be provided to the UE 10A, and may notify the UE 10A that the service is authenticated by transmitting the ProSe registration response.

The ProSe server 20 may assign the ProSe UE ID by authenticating the service, and the UE 10A and the ProSe server 20 may use the ProSe UE ID as authentication information indicating that the service is authenticated.

[1.4.2 Example of Communication Path Switching Procedure from Direct Communication to Infrastructure Communication]

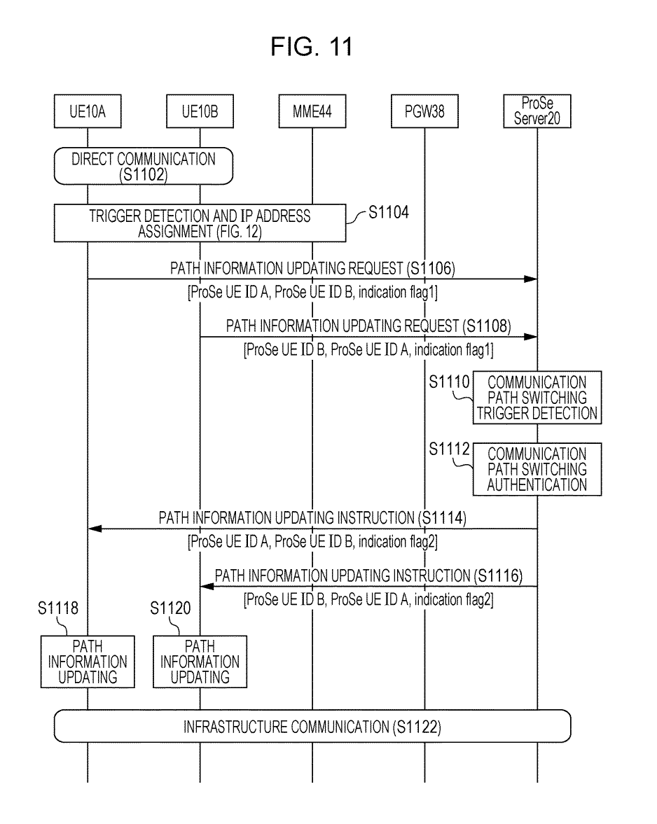

FIG. 11 is a diagram for describing an example of a communication path switching procedure from the direct communication to the infrastructure communication. In the present embodiment, the communication path switching procedure from the direct communication to the infrastructure communication in which the UE 10A or the UE 10B detects and authenticates any trigger for being connected to the network and the ProSe server 20 notifies the respective UEs 10 (UE 10A and UE 10B) of an instruction of the communication path switching procedure will be described. In the present embodiment, the description is performed using only the elements used in the description of the process, and the description of other apparatuses (eNB 52 and the like) is omitted.

Although it has been described in the present embodiment that in a case where the respective functions desire to transmit the instruction or request of the operation to the communication partner, a flag such as indication flag is added, information indicating the request may be requested by transmitted a path information updating request message through the definition of the path information updating request message in addition to the identification method using the flag. More specifically, the devices that transmit the request or the instruction may transmit the request message including a message type for requesting path information updating to a requested partner.

In the process shown in FIG. 11, the indication flag is used as the following meanings.

indication flag 1: an information element which is included in a signal transmitted from the UE 10 (UE 10A or UE 10B) to the ProSe server 20 and indicates an instruction or a request.

indication flag 2: an information element which is included in a signal transmitted from the ProSe server 20 to the UE 10 (UE 10A or UE 10B) and indicates an instruction or a request.

indication flag 3: an information element which is included in a signal transmitted from the UE 10A to the UE 10B or a signal transmitted from the UE 10B to the UE 10A and indicates an instruction or a request.

Here, the “indication flag 1” may be a flag indicating that the permission for the switching of the communication between the UEs which is defined from the direct communication T701 to the infrastructure communication T703 is requested.

That is, the UE 10A transmits information including the “indication flag 1” to the ProSe server 20, and thus, the UE 10A may request the permission for the switching of the communication path between the UE 10B and the UE 10A from the direct communication to the infrastructure communication to the ProSe server 20. The “indication flag 1” may be a flag which requests the permission for the switching of the communication between the UEs which is designated such that the switching from the direct communication T809 to the infrastructure communication T703 is performed and instructs that a signal for notifying of the permission is transmitted to a requesting transmission source in a case where the request is permitted.

That is, the UE 10A transmits the information including the “indication flag 1” to the ProSe server 20, and thus, the UE 10A can request that the ProSe server 20 permits the switching of the communication path between the UE 10B and the UE 10A from the direct communication to the infrastructure communication and can request that the ProSe server transmits a signal for notifying of the permission to the UE 10A in a case where the request is permitted.

The “indication flag 2” may be a request which switches or updates the communication path from the direct communication T701 to the infrastructure communication T703.

That is, the ProSe server 20 transmits the information including the “indication flag 2” to the UE 10A, and thus, the ProSe server 20 can request that the UE 10A switches the communication path from the direct communication to the infrastructure communication.

The “indication flag 3” may be a flag indicating the request for the registration or the updating of the path information. For example, this indication flag may request the registration or the updating of the IP address.

That is, the UE 10A transmits the information including the “indication flag 3” to the UE 10B, and thus, the UE 10A can request that the UE 10B updates the path information. For example, this indication flag may request the updating of the IP address of the UE 10A.

Hereinafter, the procedure of FIG. 11 will be described. Initially, the UE 10A and the UE 10B perform the direct communication. For example, the packets depicted in FIGS. 9(c) and 9(d) are transmitted and received in the direct communication between the UEs (S1102).

“Trigger detection and IP address assignment” (S1104) in which both or any one of the UE 10A and the UE 10B detects the switching from the direct communication to the infrastructure communication and the PGW 17 assigns the IP address to both or any one of the UE 10A and the UE 10B is performed.

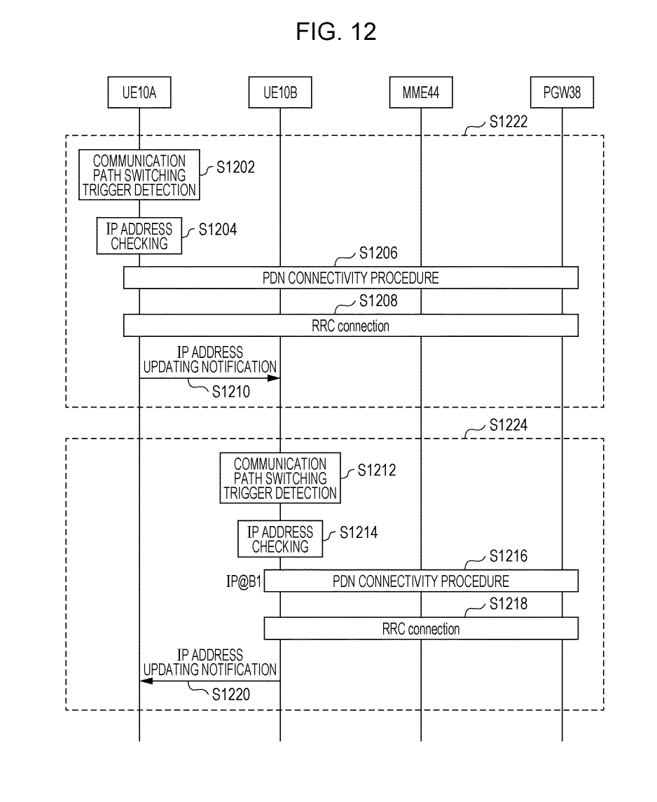

The details of S1104 will be described with reference to FIG. 12. In FIG. 12, the description is performed using only the elements used in the description of the process, and for example, the description of other apparatuses (ProSe server 20) is omitted.

The UE 10A detects a communication path switching trigger (S1202). The content of the communication path switching trigger is not particularly designated, and, for example, the UE 10A may detect that this UE moves in the coverage of the LTE network.

The UE 10A may check the IP address used in the ProSe service based on the detection (S1204). As described in ProSe Registration of 1.4.1, the UE 10A may acquire the IP address in the attach procedure, and may use this IP address in order to communicate the ProSe service via the infrastructure.

Alternatively, as described in ProSe Registration of 1.4.1, the UE 10A may acquire the IP address in the PDN connectivity procedure, and may use this IP address in order to communicate the ProSe service via the infrastructure.

Although it has been described that the UE 10A acquires the IP address based on the attach procedure by performing the attach procedure in ProSe Registration of 1.4.1, the UE may not perform the PDN connectivity procedure, and may be in a state in which the PDN connectivity procedure is not performed. In such a case, the UE 10A may newly perform the PDN connectivity procedure (S1206).

More specifically, the UE 10A transmits a PDN connectivity request message to the MME 44 and starts the PDN connectivity procedure, and the UE 10A establishes the PDN connection which is the communication path used in the infrastructure communication with the PGW 38 selected by the MME 44 based on the PDN connectivity request message. The UE 10A acquires the IP address (for example, “IP@B1”) used in the infrastructure communication from the core network 9. In contrast, the core network 9 assigns the IP address to the UE 10A based on the PDN connectivity request message transmitted from the UE 10A.

As mentioned above, the UE may perform the infrastructure communication related to the ProSe service by using the IP address different from the IP address acquired in the attach procedure.

The PDN connectivity request message including identification information indicating that the acquisition of an IP address capable of communicating with UE of a different operator is requested may be transmitted. The core network may assign an IP address capable of being routed to another operator based on such identification information. In a case where such identification information is not included, the core network may assign an IP address capable of being routed to only within an operator network. As a more specific method, the assignment of the IP address may be performed by the MME 40, or may be performed by the PGW 38.

Subsequently, the UE 10A acquires a radio resource from the network (S1208). The acquisition of the radio resource may be performed within the PDN connectivity procedure.

In a case where the UE 10A acquires the IP address in S1206, the UE 10A transmits an IP address updating notification to the UE 10B (S1210).

The IP address updating notification of S1210 includes the indication flag 3 or the information element indicating the instruction to update the IP address. The IP address updating notification may include the acquired IP address.

In a case where the UE 10A uses the IP address acquired in the attach procedure in S1204, S1206, S1208 and S1210 may be skipped.

Hereinafter, the communication path switching in the UE 10B will be described. The UE 10B detects a communication path switching trigger from the direct communication to the infrastructure communication (S1212). The communication path switching trigger is not particularly limited, and may be detected, for example, as a trigger when the own terminal (UE 10B) moves in the coverage of the LTE network, or may be detected as a trigger when the IP address updating notification is received from the communication partner (UE 10A) as in S1210.

The UE 10B may check the IP address used in the ProSe service based on the detection (S1214). As described in ProSe Registration of 1.4.1, the UE 10B may acquire the IP address in the attach procedure, and may use this IP address in order to communicate the ProSe service via the infrastructure.

Alternatively, as described in ProSe Registration of 1.4.1, the UE 10B may acquire the IP address in the PDN connectivity procedure, and may use this IP address in order to communicate the ProSe service via the infrastructure.

Although it has been described that the UE 10B acquires the IP address based on the attach procedure by performing the attach procedure in ProSe Registration of 1.4.1, the UE may not perform the PDN connectivity procedure, and may be in a state in which the PDN connectivity procedure is not performed. In such a case, the UE 10B may newly perform the PDN connectivity procedure (S1216).

More specifically, the UE 10B transmits a PDN connectivity request message to the MME 44 and starts the PDN connectivity procedure, and the UE 10B establishes the PDN connection which is the communication path used in the infrastructure communication with the PGW 38 selected by the MME 44 based on the PDN connectivity request message. The UE 10A acquires the IP address (for example, “IP@B1”) used in the infrastructure communication from the core network 9. In contrast, the core network 9 assigns the IP address to the UE 10B based on the PDN connectivity request message transmitted from the UE 10B.

As mentioned above, the UE may perform the infrastructure communication related to the ProSe service by using the IP address different from the IP address acquired in the attach procedure.

The PDN connectivity request message including identification information indicating that the acquisition of an IP address capable of communicating with UE of a different operator is requested may be transmitted. The core network may assign an IP address capable of being routed to another operator based on such identification information. In a case where such identification information is not included, the core network may assign an IP address capable of being routed to only within an operator network. As a more specific method, the assignment of the IP address may be performed by the MME 40, or may be performed by the PGW 38.

Subsequently, the UE 10B acquires a radio resource from the network (S1218). The acquisition of the radio resource may be performed within the PDN connectivity procedure.

In a case where the UE 10B acquires the IP address from the network in s1216, the UE 10B transmits an IP address updating notification to the UE 10A (S1220).

The IP address updating notification of S1220 includes the indication flag 3 or the information element indicating the instruction to update the IP address. The IP address updating notification may include the acquired IP address.

In a case where the UE 10B uses the IP address acquired in the attach procedure in S1214, S1216, S1218 and S1220 may be skipped.

The order of S1222 (S1202, S1204, S1206, S1208 and S1210) and the order of S1224 (S1212, S1214, S1216, S1218 and S1220) may be reversely performed. That is, S1222 may be performed after S1224.

Here, the description is performed by referring back to FIG. 11. The UE 10A transmits a path information updating request to the ProSe server 20 by using the detection of the communication path switching trigger in S1202, the transmission of the IP address updating notification of S1210 or the reception of the IP address updating notification in S1220 as the trigger (S1106).

The UE 10B transmits a path information updating request to the ProSe server 20 by using the detection of the communication path switching trigger in S1212, the transmission of the IP address updating notification of S1220 or the reception of the IP address updating notification in S1210 as the trigger (S1108).

The path information updating of S1106 may include the identifier (ProSe UE ID A) of the UE 10A, may include the identifier (ProSe UE ID B) of the UE 10B, or may include the indication flag 1. The path information updating request may include the plurality of these information elements.

The path information updating request of S1108 may include the identifier (ProSe UE ID A) of the UE 10A, may include the identifier (ProSe UE ID B) of the UE 10B, or may include the indication flag 1. The path information updating request may include the plurality of these information elements.

The ProSe server 20 receives both requests or any one request of the path information updating request of S1106 and the path information updating request of S1108, transmits a path information updating instruction to the UE 10A based on the reception of the path information updating request (S1114), and also transmits the path information updating instruction to the UE 10B (S1116). Accordingly, the ProSe server may request the updating of the path information.

As stated above, the ProSe server 20 may request that the UE 10A and the UE 10B update the path information based on the identification information of the UE included in the request message by receiving the path information updating request from the UE 10A. Alternatively, the ProSe server may receive the path information updating requests transmitted from the UE 10A and the UE 10B, and may request that the UE 10A and the UE 10B update the path information based on the reception of the plurality of request messages.

Although it has been described that the path information updating request of the UE 10A includes the ProSe UE ID B of the UE 10B as the information of the communication partner, the present embodiment is not limited thereto, and group identification information indicating a group that performs communication may be included. The ProSe server may acquire or retain the UE of the group identified by the group identification information, and may transmit the path information updating instruction to the UE of the group. The UE of the group may be plural in number.

Alternatively, the ProSe server 20 may detect the communication path switching trigger (S1110), and may transmit the path information updating instruction to the respective UEs 10 as the detection result.

The communication path switching trigger of S1110 is not particularly designated, and the ProSe server may detect that the UE 10A and the UE 10B are not present in proximity to each other from the UE positional information management table 226 of the storage unit 220. For example, in a case where it is determined that the UEs are not present in proximity to each other by using the positional information, the ProSe server may determine to transmit this trigger. In a case where it is determined that the UEs are sufficiently present in proximity to each other, the ProSe server may determine not to transmit this trigger.

When the path information updating instruction is transmitted, the ProSe server 20 may determine whether or not to authenticate the communication path switching (S1112), and may use the determining result as a condition in which the path information updating instruction is transmitted.

As the determination of whether or not to authenticate the communication path switching in step S1112, the ProSe server 20 may perform the determination based on whether or not the UE 10A and the UE 10B complete the service authentication by the ProSe Registration. For example, the ProSe server may perform the determination based on the authentication information such as the ProSe UE ID transmitted from the UE 10A and the UE 10B.

For example, in a case where the ProSe server 20 authenticates the communication path switching in S1112, the ProSe server 20 transmits the path information updating instruction to the UE 10A (S1114), and also transmits the path information updating instruction to the UE 10B (S1116).

The ProSe server may refuse the communication path switching in S1112, and in this case, the ProSe server may end the process, or may refuse the transmission source of the path information updating request (any one or both of the UE 10A and the UE 10B) the path information updating or may end the process after the authentication fail is notified.

The path information updating instruction of S1114 may include the identifier (for example, “ProSe UE ID A”) of the UE 10A, may include the identifier (for example, “ProSe UE ID B”) of the UE 10B, or may include the indication flag 2. The plurality of these information elements may be simultaneously included in the path information updating instruction (S1114).

The path information updating instruction of S1116 may include the identifier (for example, “ProSe UE ID A”) of the UE 10A, may include the identifier (for example, “ProSe UE ID B”) of the UE 10B, or may include the indication flag 2. The plurality of these information elements may be simultaneously included in the path information updating instruction (S1116).

The UE 10A updates the path information table 142 from the “direct communication” to the “infrastructure communication” by using the path information updating instruction (S1114) as the trigger (S1118).

Similarly, the UE 10B updates the path information table 142 from the “direct communication” to the “infrastructure communication” by using the path information updating instruction (S1116) as the trigger (S1120). Here, the UE 10A and the UE 10B may update the path information based on the path information updating instruction received from the ProSe server 20, or may not perform the switching based on the configuration or policy of the terminal or the user even though the path information updating instruction is received. With this, the UE 10A and the UE 10B start the infrastructure communication (S1122).

As described above, any one or both of the UE 10A and the UE 10B requests that the ProSe server 20 switches the communication by detecting any trigger for updating the communication between the UE 10A and the UE 10B from the direct communication to the infrastructure communication, and thus, the communication between the UE 10A and the UE 10B can be switched from the direct communication to the infrastructure communication by the instruction of the ProSe server 20.

The ProSe server 20 transmits the switching instruction to switch the communication between the UE 10A and the UE 10B from the direct communication to the infrastructure communication to the UE 10A and the UE 10B by detecting any trigger for updating the communication from the direct communication to the infrastructure communication, and thus, the communication may be switched based on the instruction.

[1.5 Operation Flow of Device]

[1.5.1 Operation Flow of UE 10A]

[1.5.1.1 Operation Flow from Trigger Detection to Path Information Updating Request Transmission]

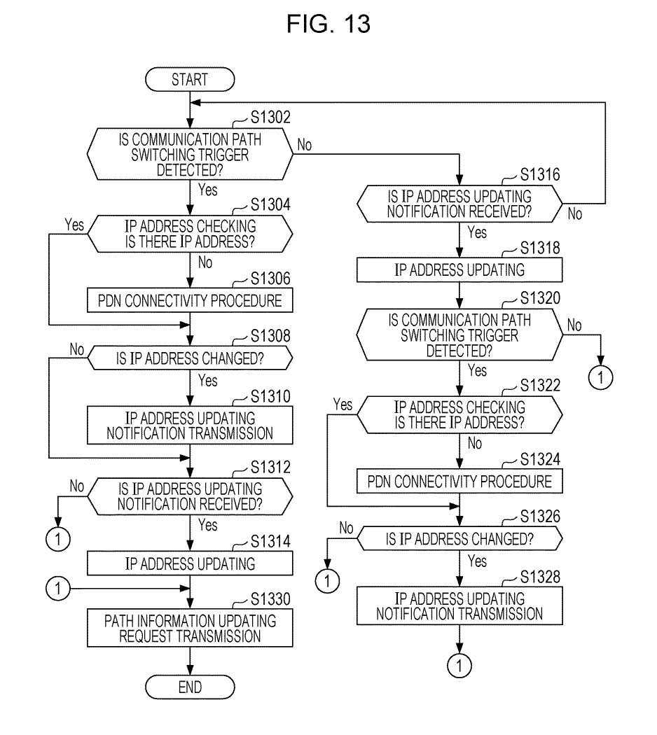

FIG. 13 shows an example of a flowchart of the UE 10A for realizing a sequence from the trigger detection (S1104) to the path information updating request transmission (S1106) in FIG. 11. The sequence until the UE 10B transmits the path information updating request (S1108) after the UE detects the trigger (S1104) is performed using the same sequence as the sequence of the UE 10A, and thus, the description thereof will be omitted.

The UE 10A detects the communication path switching trigger (step S1302). The content of the communication path switching trigger detected in step S1302 is not particularly designated, and, for example, the UE 10A may detect that this UE moves in the coverage of the LTE network.

If the UE 10A detects the communication path switching trigger in step S1302 (step S1302: Yes), the UE checks the IP address used in the infrastructure communication of the ProSe service (step S1304). In a case where the UE 10A does not retain the IP address used in the infrastructure communication of the ProSe service in step S1304 (S1304; No), the UE 10A performs the PDN connectivity procedure (step S1306).

The UE 10A acquires the IP address from the network in step S1306. That is, the network assigns the IP address to the UE 10A. However, in this case, the UE 10A may notify the network of a desired IP address.

In a case where the UE 10A previously retains the IP address used in the infrastructure communication of the ProSe service in step S1304 (step S1304; Yes) or completes the PDN connectivity procedure (step S1306), the UE 10A checks whether or not the IP address of the own terminal is changed (step S1308). Here, even in a case where the IP address used in the infrastructure communication of the ProSe service is newly acquired through the PDN connectivity, the UE 10A may check that the IP address is changed.

In a case where the IP address of the UE 10A is updated in step S1308 (step S1308; Yes), the UE 10A transmits an IP address updating notification (including the indication flag 3) to the UE 10B (step S1310).

In a case where the IP address of the UE 10A is not changed in step S1308 (step S1308; No) or after step S1310 is completed, the UE 10A checks whether or not the IP address updating notification is not received from the UE 10B (step S1312).

In a case where the UE 10A receives the IP address updating notification from the UE 10B in step S1312 (step S1312; Yes), the UE 10A updates the IP address of the UE 10B stored in the IP address management table 134 of the storage unit 130 (step S1314).

In a case where the UE 10A is not able to detect the communication path switching in step S1302 (step S1302; No), the UE 10A checks whether or not the IP address updating notification is received from the UE 10B (step S1316).

In a case where the UE 10A does not receive the IP address updating notification from the UE 10B in step S1316 (step S1316; No), the UE 10A returns to step S1302, and detects the communication path switching trigger or waits to receive the IP address updating notification.

In a case where the UE 10A receives the IP address updating notification from the UE 10B in step S1316 (step S1316; Yes), the UE 10A updates the IP address of the UE 10B stored in the IP address management table 134 of the storage unit 130 (step S1318).

Thereafter, the UE 10A checks whether or not the communication path switching trigger is detected (step S1320).

In a case where the communication path switching trigger is detected in step S1320 (step S1320; Yes), the UE 10A checks the IP address used in the infrastructure communication of the ProSe service (step S1322). In a case where the UE 10A does not retain the IP address used in the infrastructure communication of the ProSe service in step S1322 (step S1322; No), the UE 10A performs the PDN connectivity procedure (step S1324).

In step S1324, the UE 10A acquires the IP address from the network. That is, the network assigns the IP address to the UE 10A. However, in this case, the UE 10A may notify the network of a desired IP address.

In a case where the UE 10A previously retains the IP address used in the infrastructure communication of the ProSe service in step S1322 (step S1322; Yes) or in a case where the PDN connectivity procedure is completed (step S1324), the UE 10A checks whether or not the IP address of the own terminal is changed (step S1326). Here, even in a case where the IP address used in the infrastructure communication of the ProSe service is newly acquired through the PDN connectivity, the UE 10A may check that the IP address is changed.

In a case where the IP address of the UE 10A is updated in step S1326 (step S1326; Yes), the UE 10A transmits the IP address updating notification (including the indication flag 3) to the UE 10B (step S1328).

In a case where the IP address updating notification is not received in step S1312 (step S1312; No), in a case where the communication path switching trigger is not detected in step S1320 (step S1320; No), in a case where the IP address is not changed in step S1326 (step S1326; No), or after step S1314 is completed, the UE 10A transmits the path information updating request to the ProSe server 20 (step S1330).

As described above, the flow until the UE 10A transmits the path information updating request to the ProSe server 20 after the UE detects the communication path switching trigger has been described.

As described above, the UE 10A may determine to switch the communication between the UE 10A and the UE 10B from the direct communication using LTE to the infrastructure communication performed via the core network, and may transmit the path information updating request message to the ProSe server 20 that manages the communication between the UE 10A and the UE 10B. The first identification information may indicate at least the request for the switching of the communication between the UE 10A and the UE 10B to the infrastructure communication to the path information updating request. The UE may request that the ProSe server 20 switches the communication between the UE 10A and the UE 10B to the infrastructure communication.

[1.5.1.2 Operation Flow from Path Information Updating Instruction Reception to Path Information Updating]

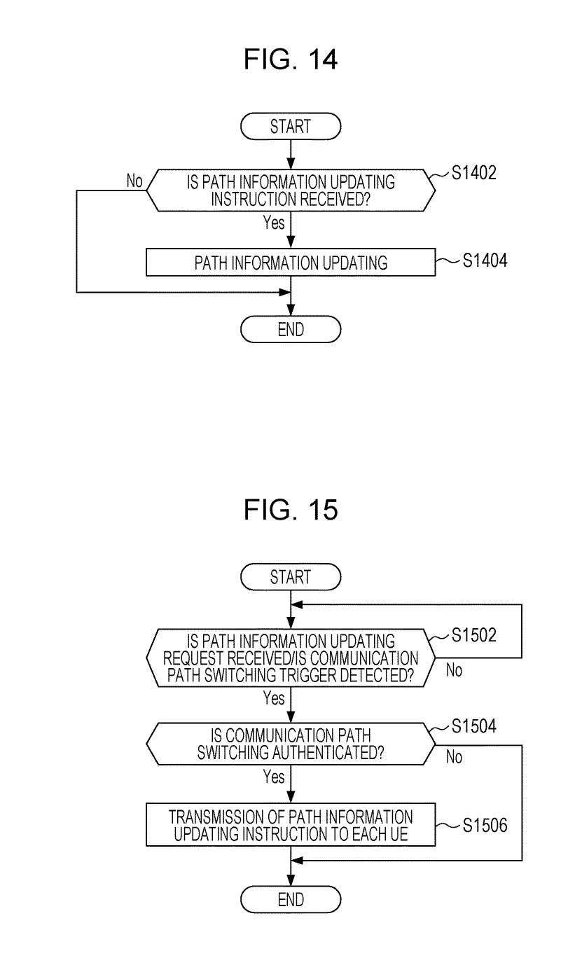

Hereinafter, a flow until the UE 10A updates the path information after the UE receives the path information updating instruction from the ProSe server 20 will be described with reference to FIG. 14. The sequence until the UE 10B updates the path information after the UE receives the path information updating instruction from the ProSe server 20 is performed using the same sequence as the sequence of the UE 10A, and thus, the detailed description thereof will be omitted.

it is assumed that the flow of FIG. 14 does not depend on whether or not the flow shown in FIG. 13 is performed.

The UE 10A waits to receive the path information updating instruction from the ProSe server 20 (step S1402). In a case where the path information updating instruction is not received in step S1402 (step S1402; No), the process is ended.

In a case where the UE 10A receives the path information updating instruction from the ProSe server 20 (step S1402; Yes), the UE 10A updates the path information table 142 of the storage unit 130 from the “direct communication” to the “infrastructure communication” (step S1404). In this case, the UE 10A may release the radio resource used in the direct communication using LTE. With this, the process is ended.

As described above, the UE 10A may be the terminal device that performs the direct communication with the UE 10B using LTE. The UE may receive, as the request message including at least the indication flag 2, the path information updating instruction from the ProSe server 20. The path information updating instruction may indicate the request for the switching of the communication between the terminal devices from the direct communication using LTE to the infrastructure communication performed via the core network. The UE may switch from the direct communication using LTE to the infrastructure communication performed via the core network based on the reception of the path information updating instruction, and may continue the communication with the UE 10B.

That is, the control method of the UE 10A that performs the direct communication using LTE with the UE 10B may include the step of receiving, as the request message including at least the indication flag 2, the path information updating instruction from the ProSe server 20. The path information updating instruction may indicate at least the request for the switching of the communication between the terminal devices from the direct communication using LTE to the infrastructure communication performed via the core network. The control method may include the step of switching from the direct communication using LTE to the infrastructure communication performed via the core network based on the reception of the path information updating instruction and continuing the communication with the UE 10B.

The UE 10A may transmit, as the request message including at least the indication flag 1, the path information updating request to the ProSe server 20. The path information updating request may indicate at least the request for the switching of the communication between the terminal devices from the direct communication using LTE to the infrastructure communication performed via the core network. The UE may receive, as the response to the path information updating request, the path information updating instruction.

That is, the control method of the UE 10A may include the step of transmitting, as the request message including at least the indication flag 1, the path information updating request to the ProSe server 20. The path information updating request may indicate at least the request for the switching of the communication between the terminal devices from the direct communication using LTE to the infrastructure communication performed via the core network. The control method may further include the step of receiving, as the response to the path information updating request, the path information updating instruction.

The UE 10A may release the resource for the direct communication using LTE after the switching from the direct communication using LTE to the infrastructure communication performed via the core network is performed.

That is, the control method of the UE 10A may further include the step of releasing the resource for the direct communication using LTE after the switching from the direct communication using LTE to the infrastructure communication performed via the core network is performed.

[1.5.2 Operation Flow of ProSe Server 20]

FIG. 15 shows a flow until the ProSe server 20 transmits the path information updating instruction to the UE 10A and the UE 10B after the ProSe server 20 receives the path information updating request from at least any one of the UE 10A and the UE 10B or the ProSe server autonomously detects the communication path switching.

The ProSe server 20 receives the path information updating request (including the indication flag 1) from any one or both of the UE 10A and the UE 10B, or the ProSe server 20 waits to detect the communication path switching trigger (step S1502).

The communication path switching trigger of step S1502 is not particularly designated, and, for example, the ProSe server 20 may detect that the UE 10A and the UE 10B are not present in proximity to each other from the UE positional information management table 226 of the storage unit 220.

In a case where the ProSe server 20 detects any one of the above-described triggers in step S1502 (step S1502; Yes), the ProSe server 20 determines whether or not to authenticate the communication path switching (step S1504).

Here, as the determination of whether or not to authenticate the communication path switching in step S1504, the ProSe server 20 may perform the determination based on whether or not the UE 10A and the UE 10B complete the service authentication by the ProSe Registration. For example, the ProSe server may perform the determination based on the authentication information such as the ProSe UE ID transmitted from the UE 10A and the UE 10B.

In a case where the ProSe server 20 authenticates the communication path switching in step S1504, the ProSe server 20 transmits the path information updating instruction to the respective UEs 10 (UE 10A and UE 10B) (S1506). With this, the description of the operation flow in the ProSe server 20 is completed.

As described above, the ProSe server 20 may transmit, as the request message including at least the indication flag 2, the path information updating instruction to the UE 10B that performs the direct communication using LTE with the UE 10A. The path information updating instruction may indicate at least the request for the switching of the communication between the terminal devices from the direct communication using LTE to the infrastructure communication performed via the core network. The ProSe server may transmit, as the request message including at least the indication flag 2, the path information updating instruction to the UE 10A. The path information updating instruction may indicate at least the request for the switching of the communication between the terminal devices from the direct communication using LTE to the infrastructure communication performed via the core network.

That is, the communication control method of the ProSe server 20 may include the step of transmitting, as the request message including at least the indication flag 2, the path information updating instruction to the UE 10B that performs the direct communication using LTE with the UE 10A. The path information updating instruction may indicate at least the request for the switching of the communication between the terminal devices from the direct communication using LTE to the infrastructure communication performed via the core network. The communication control method may include the step of transmitting, as the request message including at least the indication flag 2, the path information updating instruction to the UE 10A.

The ProSe server 20 may receive, as the request message which includes at least the indication flag 1 and is transmitted from the UE 10B, the path information updating request. The path information updating request may indicate at least the request for the switching of the communication between the terminal devices from the direct communication using LTE to the infrastructure communication performed via the core network. The ProSe server may transmit the path information updating instruction based on the reception of the path information updating request.

That is, the communication control method of the ProSe server 20 may include the step of receiving, as the request message which includes at least the indication flag 1 and is transmitted from the UE 10B, the path information updating request. The path information updating request may indicate at least the request for the switching of the communication between the terminal devices from the direct communication using LTE to the infrastructure communication performed via the core network. The communication control method may further include the step of transmitting the path information updating instruction based on the reception of the path information updating request.

### 2. Second Embodiment

Hereinafter, a second embodiment will be described. The functional structures of the systems according to the second embodiment and the first embodiment are the same, and thus, the process flow and the operation flow different from those of the first embodiment will be mainly described.

Although the method in which when the communication path of the communication between the UEs is switched from the direct communication to the infrastructure communication, each UE receives the path information updating instruction from the ProSe server, and thus, each UE updates the path information has been described in the first embodiment, a method in which the ProSe server transmits the path information updating instruction to only any one of the UEs and the UE that receives the path information updating instruction transmits the path information updating instruction to the communication partner, and thus, each UE updates the path information will be described in the second embodiment.

[2.1 Processing Example]

[2.1.1 Example of Communication Path Switching Procedure from Direct Communication to Infrastructure Communication]

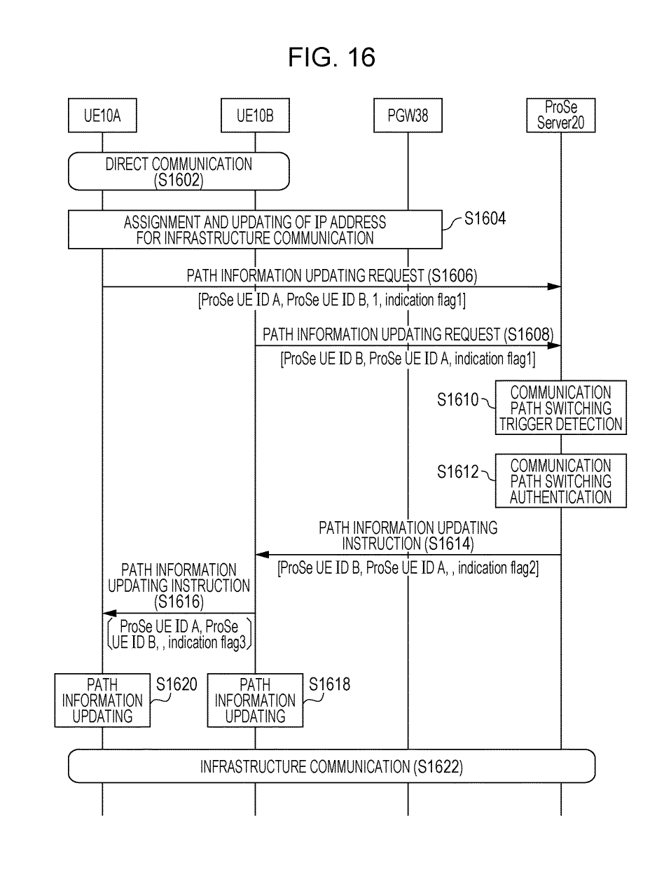

FIG. 16 is a conceptual diagram of the communication path switching, communication path switching and selection of the communication path performed in the present embodiment.

In the present embodiment, for example, it is assumed that the ProSe server 20 transmits the path information updating instruction to the UE 10B.

Although it has been described in the present embodiment that in a case where the respective functions desire to transmit the instruction or request of the operation to the communication partner, a flag such as indication flag is added, information indicating the request may be requested by transmitted a path information updating request message through the definition of the path information updating request message in addition to the identification method using the flag. More specifically, the devices that transmit the request or the instruction may transmit the request message including a message type for requesting path information updating to a requested partner.

In the process shown in FIG. 16, the indication flag is used as the following meanings.

indication flag 1: an information element which is included in a signal transmitted from the UE 10 (UE 10A or UE 10B) to the ProSe server 20 and indicates an instruction or a request.

indication flag 2: an information element which is included in a signal transmitted from the ProSe server 20 to the UE 10 (UE 10A or UE 10B) and indicates an instruction or a request.

indication flag 3: a first information element which is included in a signal transmitted from the UE 10A to the UE 10B or a signal transmitted from the UE 10B to the UE 10A and indicates an instruction or a request.

Here, the function of the “indication flag 1” is executed using the same function as the function in the first embodiment, and thus, the detailed description thereof will be omitted.

The “indication flag 2” may include the function described in the first embodiment.

That is, the ProSe server 20 transmits the information including the “indication flag 2” to the UE 10A, and thus, the ProSe server 20 can request that the UE 10A switches the communication path from the direct communication to the infrastructure communication.

The “indication flag 2” may include an instruction for instructing that the reception UE transmits a signal for instructing the changing of the path information from the direct communication to the infrastructure communication to the communication partner.

That is, the ProSe server 20 transmits the path information updating instruction including the “indication flag 2” to the UE 10B, and thus, the ProSe server 20 may request that the UE 10B transmits a signal for instructing the updating of the communication between the UE 10A and the UE 10B from the direct communication to the infrastructure communication to the UE 10A.

The function of the “indication flag 3” is executed using the same function as the function in the first embodiment, and thus, the detailed description thereof will be omitted. For example, the indication flag 3 may indicate the request for the switching of the communication between the terminal devices from the direct communication using LTE to the infrastructure communication performed via the core network.

That is, the UE 10B transmits the signal including the “indication flag 3” to the UE 10A, and thus, the UE 10B may request that the UE 10A switches the communication between the terminal devices from the direct communication using LTE to the infrastructure communication performed via the core network.

Initially, the UE 10A and the UE 10B perform the direct communication. For example, in the direct communication between the UEs, the packets shown in FIGS. 9(c) and 9(d) are transmitted and received (S1602). S1602 may be performed similarly to S1102.

Trigger detection and IP address assignment (S1604) in which both or any one of the UE 10A and the UE 10B detects the switching from the direct communication to the infrastructure communication and the PGW 38 assigns the IP address to both or any one of the UE 10A and the UE 10B are performed. S1604 may be performed using the same procedure as the procedure of S1104, and thus, the detailed description thereof will be omitted.

Subsequently, the UE 10A transmits the path information updating request to the ProSe server 20 by using the detection of the communication path switching trigger of S1202, the transmission of the IP address updating notification of S1210 or the reception of the IP address updating notification of S1220 as the trigger (S1606).

The UE 10B transmits the path information updating request to the ProSe server 20 by using the detection of the communication path switching trigger of S1212, the transmission of the IP address updating notification of S1220 or the reception of the IP address updating notification of S1210 as the trigger (S1608).

The path information updating request of S1606 may include the identifier (ProSe UE ID A) of the UE 10A, may include the identifier (ProSe UE ID B) of the UE 10B, or may include the indication flag 1. The path information updating request may include the plurality of these information elements.

The path information updating request of S1608 may include the identifier (ProSe UE ID A) of the UE 10A, may include the identifier (ProSe UE ID B) of the UE 10B, or may include the indication flag 1. The path information updating request may include the plurality of these information elements.

Here, S1606 is performed similarly to S1106, and S1608 may be performed using the same procedure as that of S1108.

Subsequently, the ProSe server 20 receives both requests or any one request of the path information updating request of S1606 and the path information updating request of S1608, and transmits the path information updating instruction to the UE 10B based on the reception of the path information updating request (S1614). Accordingly, the ProSe server may request the updating and transmission of the path information.

As stated above, the ProSe server 20 may request that the UE 10B updates the path information together with the identification information of the UE included in the request message by receiving the path information updating request from the UE 10A. Alternatively, the ProSe server may receive the path information updating requests which are respectively transmitted from the UE 10A and the UE 10B, may receive the plurality of these request messages, and may request that the UE 10B updates the path information.

Although it has been described that the path information updating request of the UE 10A includes the ProSe UE ID B of the UE 10B as the information of the communication partner, the present embodiment is not limited thereto, and group identification information indicating a group that performs communication may be included. The ProSe server may acquire or retain the UE of the group identified by the group identification information, and may transmit the path information updating instruction to the UE of the group. The UE of the group may be plural in number.

The ProSe server 20 may detect the communication path switching trigger (S1610), and may transmit the path information updating instruction to the UE 10B as the detecting result.

The communication path switching trigger of S1610 is not particularly designated, and the ProSe server may detect that the UE 10A and the UE 10B are not present in proximity to each other from the UE positional information management table 226 of the storage unit 220. For example, in a case where it is determined that the UEs are not present in proximity to each other by using the positional information, the ProSe server may determine to transmit this trigger. In a case where it is determined that the UEs are sufficiently present in proximity to each other, the ProSe server may determine not to transmit this trigger.

When the path information updating instruction is transmitted, the ProSe server 20 may determine whether or not to authenticate the communication path switching (S1612), and may use the determining result as a condition in which the path information updating instruction is transmitted.

S1610 and S1612 may be respectively performed using the same procedures as the procedures of S1110 and S1112, and thus, the detailed description thereof will be omitted.

In a case where the ProSe server 20 authenticates the communication path switching in S1612, the ProSe server 20 transmits the path information updating instruction to the respective UE 10B (S1614).

The path information updating instruction of S1614 may include the identifier (for example, “ProSe UE ID A”) of the UE 10A, may include the identifier (for example, “ProSe UE ID B”) of the UE 10B, or may include the indication flag 2. The plurality of these information elements may be simultaneously included in the path information updating instruction (S1614).

The UE 10B transmits the path information updating instruction to the UE 10A by using the reception of the path information updating instruction (S1614) as the trigger (S1616). The UE updates the stored information of the path information table 142 of the UE 10A from the “direct communication” to the “infrastructure communication”, simultaneously with the transmission of the path information updating instruction or after the checking of whether or not a refusal response is received from the UE 10A (S1618).

The path information updating instruction from the UE 10A from the UE 10B of S1616 may be transmitted using the direct communication, or may be transmitted after the direct communication is changed to the infrastructure communication.

The path information updating instruction of S1616 may include the identifier (for example, “ProSe UE ID A”) of the UE 10A, may include the identifier (for example, “ProSe UE ID B”) of the UE 10B, or may include the indication flag 3. The plurality of these information elements may be simultaneously included in the path information updating instruction (S1616).

The UE 10A updates the path information table 142 from the “direct communication” to the “infrastructure communication” by using the path information updating instruction (S1616) as the trigger (S1620).

Here, the UE 10A and the UE 10B may update the path information based on the path information updating instruction received from the ProSe server 20, or may not perform the switching based on the configuration or policy of the terminal or the user even though the path information updating instruction is received.

With this, in a case where the UE 10A and the UE 10B update the path information, the UE 10A and the UE 10B start the infrastructure communication (S1622).

As stated above, any one or both of the UE 10A and the UE 10B or the ProSe server 20 detects any trigger for switching the communication path of the communication between the UE 10A and the UE 10B from the direct communication to the infrastructure communication, so that the UE may request that the ProSe server 20 switches the communication, the ProSe server 20 may transmit the path information updating instruction to the UE 10A or the UE 10B, and the UE that receives the path information updating instruction may transmit the path information updating instruction to the communication partner.

Accordingly, it is possible to switch the communication path of the communication between the UEs from the direct communication to the infrastructure communication.

[2.2 Operation Flow of Device]

[2.2.1 Operation Flow of UE 10A]

[2.2.1.1 Operation Flow from Path Information Updating Instruction Reception to Path Information Updating]

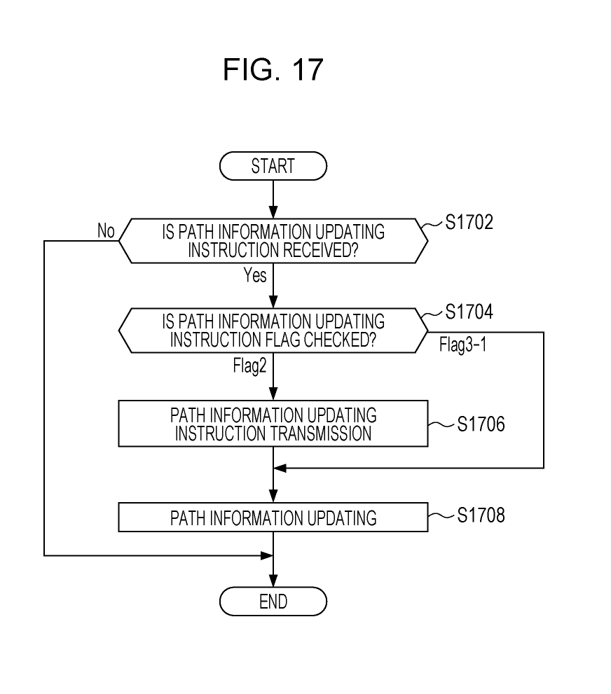

FIG. 17 shows an operation flow until the UE 10B of FIG. 16 updates the path information after the UE receives the path information updating instruction. The UE 10A may use the same system as the operation system of the UE 10B, and thus, the detailed description related to the UE 10A will be omitted.

The flow until the UE 10A and the UE 10B transmit the path information updating requests to the ProSe server 20 after these UEs detect the path information updating triggers may be performed using the same flow as the flow of the first embodiment, and thus, the detailed description thereof will be omitted.

Initially, the UE 10B waits to receive the path information updating instruction (step S1702). In step S1702, in a case where the UE 10B does not receive the path information updating instruction (step S1702; No), the process may be ended.

In a case where the UE 10B receives the path information updating instruction (step S1702; Yes), the UE 10B checks the information element or the instruction indicating the instruction or the request included in the received path information updating instruction (step S1704).

In the example described in the present embodiment, the path information updating instruction received by the UE 10B includes the “indication flag 2” or the “indication flag 3”. In a case where the indication flag included in the path information updating instruction received by the UE 10B is the “indication flag 4” (step S1704; Flag 2), the UE 10B transmits the path information updating instruction (including the “indication flag 3”) to the UE 10A (step S1706).

In a case where the indication flag included in the path information updating instruction is the “indication flag 3” in step S1704 (step S1704; Flag 3) or after step S1706 is completed, the UE 10B updates the path information of the communication with the UE 10A from the “direct communication” to the “infrastructure communication” (step S1708). In this case, the UE 10A may release the radio resource used in the direct communication using LTE.

As mentioned above, the UE 10B is the terminal device that performs the direct communication using LTE with the UE 10A. The UE may receive, as the request message including at least the indication flag 2, the path information updating instruction from the ProSe server 20. The path information updating instruction may indicate the request for the switching of the communication between the terminal devices from the direct communication using LTE to the infrastructure communication performed via the core network. The UE may switch from the direct communication using LTE to the infrastructure communication performed via the core network based on the reception of the path information updating instruction, and may continue the communication with the UE 10A.

That is, the control method of the UE 10B that performs the direct communication using LTE with the UE 10A may include the step of receiving, as the request message including at least the indication flag 2, the path information updating instruction from the ProSe server 20. The path information updating instruction may indicate at least the request for the switching of the communication between the terminal devices from the direct communication using LTE to the infrastructure communication performed via the core network. The control method may include the step of switching from the direct communication using LTE to the infrastructure communication performed via the core network based on the reception of the path information updating instruction and continuing the communication with the UE 10A.

The UE 10B may transmits, as the request message including at least the indication flag 1, the path information updating request to the ProSe server 20. The path information updating request may indicate at least the request for the switching of the communication between the terminal devices from the direct communication using LTE to the infrastructure communication performed via the core network. The UE may receive, as the response to the path information updating request, the path information updating instruction.

That is, the control method of the UE 10B may include the step of transmitting, as the request message including at least the indication flag 1, the path information updating request to the ProSe server 20. The path information updating request may indicate at least the request for the switching of the communication between the terminal devices from the direct communication using LTE to the infrastructure communication performed via the core network. The control method may further include the step of receiving, as the response to the path information updating request, the path information updating instruction.

The UE 10B may transmit the request message “path information updating instruction” including the “indication flag 3” to the UE 10A based on the reception of the path removal updating instruction from the ProSe server 20. The path information updating instruction may indicate at least the request for the switching of the communication between the terminal devices from the direct communication using LTE to the infrastructure communication performed via the core network.

That is, the communication control method of the UE 10B may further include the step of transmitting the request message “path information updating instruction” including the indication flag 3 to the UE 10A based on the reception of the path information updating instruction from the ProSe server 20. The path information updating instruction may indicate at least the request for the switching of the communication between the terminal devices from the direct communication using LTE to the infrastructure communication performed via the core network.

The UE 10B may release the resource for the direct communication using LTE after the switching from the direct communication using LTE to the infrastructure communication performed via the core network is performed.

That is, the control method of the UE 10B may further include the step of releasing the resource for the direct communication using LTE after the switching from the direct communication using LTE to the infrastructure communication performed via the core network is performed.

The flow of the UE 10A may be basically performed using the same flow as the flow of The UE 10B, and thus, the detailed description thereof will be omitted.

[2.2.2 Operation Flow of ProSe Server 20]

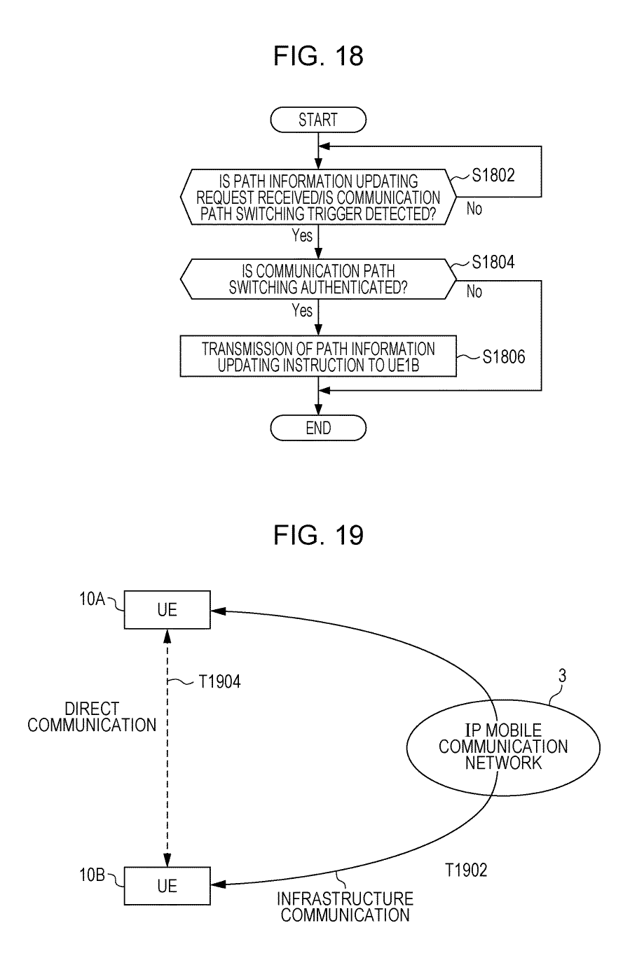

FIG. 18 shows a flow until the ProSe server 20 transmits the path information updating instruction to the UE 10A and the UE 10B after the ProSe server 20 receives the path information updating request from at least any one of the UE 10A and the UE 10B or the ProSe server autonomously detects the communication path switching.

The ProSe server 20 receives the path information updating request (including the indication flag 1) from any one or both of the UE 10A and the UE 10B, or the ProSe server 20 waits to detect the communication path switching trigger (step S1802).

The communication path switching trigger of step S1802 is not particularly designated, and the ProSe server 20 may detect that the UE 10A and the UE 10B are not present in proximity to each other from the UE positional information management table 226 of the storage unit 220.

In a case where the ProSe server 20 detects any one of the above-described triggers in step S1802 (step S1802; Yes), the ProSe server 20 determines whether or not to authenticate the communication path switching (step S1804).

Here, as the determination of whether or not to authenticate the communication path switching in step S1804, the ProSe server 20 may perform the determination based on whether or not the UE 10A and the UE 10B complete the service authentication by the ProSe Registration. For example, the ProSe server may perform the determination based on the authentication information such as the ProSe UE ID transmitted from the UE 10A and the UE 10B.

In a case where the ProSe server 20 authenticates the communication path switching in step S1804, the ProSe server 20 transmits the path information updating instruction to the respective UEs (UE 10A and UE 10B) (S1806). Although it has been described in the present embodiment that the ProSe server 20 transmits the path information updating instruction to the UE 10B, the ProSe server may transmit the path information updating instruction to the UE 10A. With this, the description of the operation flow in the ProSe server 20 is completed.

As stated above, the ProSe server 20 transmits the request message “path information updating instruction” including at least the indication flag 2 to the UE 10B that performs the direct communication using LTE with the UE 10A. The path information updating instruction may indicate at least the request for the switching of the communication between the terminal devices from the direct communication using LTE to the infrastructure communication performed via the core network.

That is, the communication control method of the ProSe server 20 may include the step of transmitting the request message “path information updating instruction” including at least the indication flag 2 to the UE 10B that performs the direct communication using LTE with the UE 10A. The path information updating instruction mentioned herein indicates at least the request for the switching of the communication between the terminal devices from the direct communication using LTE to the infrastructure communication performed via the core network.

The ProSe server 20 may transmit the request message “path information updating instruction” including at least the indication flag 2 to the UE 10B that performs the direct communication using LTE with the UE 10A. The path information updating instruction may indicate at least the request for the switching of the communication between the terminal devices from the direct communication using LTE to the infrastructure communication performed via the core network and the transmission of the request message for switching the communication between the terminal devices from the direct communication using LTE to the infrastructure communication performed via the core network to the UE 10A.

That is, the communication control method of the ProSe server 20 may further include the step of transmitting the request message “path information updating instruction” including at least the indication flag 2 to the UE 10B that performs the direct communication using LTE with the UE 10A. The path information updating instruction may indicate at least the request for the switching of the communication between the terminal devices from the direct communication using LTE to the infrastructure communication performed via the core network and the transmission of the request message for switching the communication between the terminal devices from the direct communication using LTE to the infrastructure communication performed via the core network to the UE 10A.

The ProSe server 20 may receive the request message “path information updating request” which includes at least the indication flag 1 and is transmitted from the UE 10B. The path information updating request may indicate at least the request for the switching of the communication between the terminal devices from the direct communication using LTE to the infrastructure communication performed via the core network. The ProSe server may transmit the path information updating instruction based on the reception of the path information updating request.

That is, the communication control method of the ProSe server 20 may further include the step of receiving the request message “path information updating request” which includes at least the indication flag 1 and is transmitted from the UE 10B, and the step of the transmitting the path information updating instruction based on the reception of the path information updating request. Here, the path information updating request indicates at least the request for the switching of the communication between the terminal devices from the direct communication using LTE to the infrastructure communication performed via the core network.

### 3. Third Embodiment

Hereinafter, a third embodiment will be described.

The functional structures of the systems according to the third embodiment and the first embodiment are the same, and thus, the process flow and the operation flow different from those of the first embodiment will be mainly described.

Although the embodiments related to the case where the communication between the UEs is switched from the direct communication to the infrastructure communication have been described in the first embodiment and the second embodiment, a method of switching the communication path of the communication between the UEs from the infrastructure communication to the direct communication will be described in the third embodiment.

[3.1 Description of Process]

[3.1.1 Outline]

FIG. 19 is a conceptual diagram of the communication path switching, communication path switching and selection of the communication path performed in the present embodiment.

In an initial state of the present embodiment, the UE 10A and the UE 10B perform communication using a communication path depicted as infrastructure communication T1902 (solid line).

The infrastructure communication T1902 is communication via the network such as EPC. The infrastructure communication means that the UE establishes PDN connection with the PGW and performs communication by using this PDN connection. The core network selects the PGW connected to the PDN when the PDN connection is established.

Any trigger occurs in the UE or the network, and thus, switching from the initial state to direct communication T1904 (dashed line) is performed.

In the Present embodiment, the UE 10B switches the communication path between the UE 10B and the UE 10A from the infrastructure communication (T1902) to the direct communication (T1904) while continuing the service. When the communication path is switched, the UE 10B selects the communication path.

[3.2 Processing Example]

[3.2.1 Example of Communication Path Switching Procedure from Infrastructure Communication to Direct Communication]

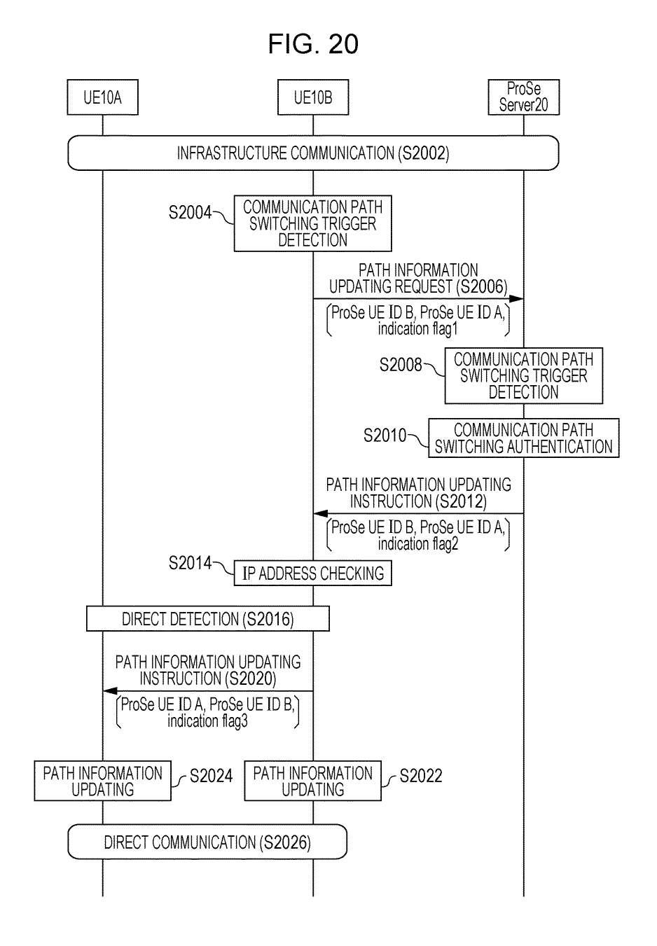

FIG. 20 is a diagram for describing a communication path switching procedure from the infrastructure communication to the direct communication. In the present embodiment, a method in which the UE 10A or the UE 10B detects any one trigger for being connected to the network, the ProSe server 20 notifies each UE of the communication path switching, and the ProSe server 20 permits the communication path switching and establishes the direct communication path between the UEs will be described. In the present embodiment, the description is performed using only the elements used in the description of the process, and the description of other apparatuses (eNB 52 and the like) is omitted.

Although it has been described in the present embodiment that in a case where the respective functions desire to transmit the instruction or request of the operation to the communication partner, a flag such as indication flag is added, information indicating the request may be requested by transmitted a path information updating request message through the definition of the path information updating request message in addition to the identification method using the flag. More specifically, the devices that transmit the request or the instruction may transmit the request message including a message type for requesting path information updating to a requested partner.

In the process shown in FIG. 20, the indication flag is used as the following meanings.

indication flag 1: an information element which is included in a signal transmitted from the UE 10 (UE 10A or UE 10B) to the ProSe server 20 and indicates an instruction or a request.

indication flag 2: an information element which is included in a signal transmitted from the ProSe server 20 to the UE 10 (UE 10A or UE 10B) and indicates an instruction or a request.

indication flag 3: an information element which is included in a signal transmitted from the UE 10A to the UE 10B or a signal transmitted from the UE 10B to the UE 10A and indicates an instruction or a request.

Here, the “indication flag 1” may be a flag indicating that the permission for the switching of the communication between the UEs which is designated such that the switching from the infrastructure communication T1902 to the direct communication T1904 is requested.

That is, the UE 10B transmits the information including the “indication flag 1” to the ProSe server 20, and thus, the UE 10B may request that the ProSe server 20 permits the switching of the communication path between the UE 10A and the UE 10B from the infrastructure communication to the direct communication.

The “indication flag 1” may be a flag which requests the switching of the designated communication between the UEs from the infrastructure communication T1902 to the direct communication T1904 and instructs the transmission of the signal for notifying the requesting transmission source of the permission in a case where the request is permitted.

That is, the UE 10B transmits the information including the “indication flag 1” to the ProSe server 20, and thus, the UE 10B may request that the ProSe server 20 permits the switching of the communication path of the direct communication between the UE 10B and the UE 10A from the infrastructure communication to the direct communication, and may request that the ProSe server transmits the signal for notifying the UE 10B of the permission in a case where the request is permitted.

The “indication flag 2” may be a request that the communication path from the infrastructure communication T1902 to the direct communication T1904 is switched or updated.

That is, the ProSe server 20 transmits the information including the “indication flag 2” to the UE 10B, and thus, the ProSe server 20 may request that the UE 10B switches the communication path from the infrastructure communication to the direct communication.

The “indication flag 2” may request the checking of the IP address used in the direct communication of the ProSe service with the designated communication partner, the establishment of the communication path by the checking result, and the instruction for the path information updating.

That is, the ProSe server 20 transmits the path information updating instruction including the indication flag 2 to the UE 10B, and thus, the ProSe server 20 may request that the UE 10B checks the IP address used in the direct communication of the ProSe service with the UE 10A and performs the establishment procedure of the communication path by the checking result and the UE 10B transmits the path information updating instruction to the UE 10A.

The “indication flag 3” may be a flag indicating the request for the updating of the path information. For example, this flag may request that the communication with the transmission source is switched from the infrastructure communication to the direct communication.

That is, the UE 10B transmits the signal including the indication flag 3 to the UE 10A, and thus, this UE may request the updating of the path information. For example, the UE 10B may request that the UE 10A switches the communication between the UE 10A and the UE 10B from the infrastructure communication to the direct communication.

Initially, as the initial state, the UE 10A and the UE 10B perform the infrastructure communication (S2002). S2002 may be performed similarly to S1122 or S1622.

Subsequently, the UE 10B detects the communication path switching trigger (S2004). The trigger of S2004 is not particularly limited, and, for example, a case where it is detected that the UE 10B moves outside the coverage of the access network or the UE 10B is present in the proximity of the UE 10A is considered.

The UE 10B transmits the path information updating request to the ProSe server 20 by using S2004 as the trigger (S2006). The path information updating request of S2006 may include the identifier (for example, “ProSe UE ID B”) of the UE 10B, may include the identifier (for example, “ProSe UE ID A”) of the UE 10A, or may include the indication flag 1.

Thereafter, the ProSe server 20 receives the path information updating request of S2006, and transmits the path information updating instruction to the UE 10B based on the reception of the path information updating request.

As mentioned above, the ProSe server 20 may receive the path information updating request from the UE 10B, and thus, the ProSe server may request that the UE 10B updates the path information based on the identification information of the UE included in the request message.

Although the example in which the path information updating request of the UE 10B the ProSe UE ID A of the UE 10A as the information of the communication partner has been described, the present embodiment is not limited thereto, and the path information updating request may be group identification information indicating a group that performs communication. The ProSe server may acquire or retain the UE of the group identified by the group identification information, and may transmit the path information updating instruction to the UE of the group. The UE of the group may be plural in number.

Alternatively, the ProSe server 20 may detect the communication path switching trigger (S2008), and may transmit the path information updating instruction to the UE 10B as the detecting result.

The communication path switching trigger of the ProSe server 20 is not particularly designated, and, for example, a case where it is detected that the UEs are present in proximity to each other from the positional information of the UE stored in the UE positional information management table 226 of the storage unit 220 of the ProSe server 20 is considered. For example, in a case where it is determined that the UEs are sufficiently present in proximity to each other by the positional information, the ProSe server may transmit the path information updating instruction. In a case where it is determined that the UEs are not present in proximity to each other, the ProSe server may determine not to transmit the path information updating instruction.

When the path information updating instruction is transmitted, the ProSe server 20 may determine whether or not to authenticate the communication path switching (S2010), and may use the determining result as a condition in which the path information updating instruction is transmitted.

The authentication determination method of the communication path switching of S2010 may be performed based on whether or not the UE 10A and the UE 10B complete the service authentication by the ProSe Registration. For example, the ProSe server may perform the determination based on the authentication information such as the ProSe UE ID transmitted from the UE 10A and the UE 10B.

For example, in a case where the ProSe server 20 does not authenticate the communication path switching in S2010, the process is ended. The UE 10B detects that the request is refused based on the fact that there is no response. Before the ProSe server 20 ends the process, the ProSe server may transmit a refusal response to the UE 10B.

In a case where the ProSe server 20 authenticates the communication path switching in S2010, the ProSe server 20 transmits the path information updating instruction to the UE 10B (S2012).

The path information updating instruction of S2012 may include the identifier (for example, “ProSe UE ID B”) of the UE 10B, the identifier (for example, “ProSe UE ID A”) of the UE 10A, or the indication flag 2, or may add the plurality of these information elements to a plurality of path information updating instructions.

The UE 10B may check the IP address used in the ProSe service based on the detection (S2014). In a case where the UE 10B does not store the IP address used in association with the ProSe service, the UE 10B directly detects the UE 10A (S2016).

As the specific method, the UE 10B transmits the request for the detection to the UE 10A and the UE 10A transmits the response to the UE 10B, so that the UE 10B may directly detect the UE 10A. In this case, the UE 10B may allocate the radio resource. Accordingly, this UE may establish the communication path of the direct communication.

By using the completion of the communication path establishment (S2018) of the direct communication or the transmission of the path information updating instruction to the UE 10A (S2020) as the trigger, the UE 10B updates the path information of the UE 10B to the UE 10A to the direct communication (S2022).

The UE 10A updates the path information of the UE 10A to the UE 10B to the direct communication by using S2020 as the trigger (S2024).

By doing this, the UE 10A and the UE 10B perform the direct communication (S2026). S2026 may be performed similarly to S1102.

Any one of the UE 10A and the UE 10B detects the communication path switching trigger for switching from the infrastructure communication to the direct communication and transmits the path information updating request to the ProSe server 20, the ProSe server 20 may instruct any one of the UEs switches the communication path, and may switch the communication between the UE 10A and the UE 10B from the infrastructure communication to the direct communication.

The ProSe server 20 detects the communication path switching trigger of the communication between the UEs, and thus, the ProSe server 20 may transmit the instruction for the communication path switching to any one of the UEs, and may switch the communication between the UE 10A and the UE 10B from the infrastructure communication to the direct communication based on the instruction.

[3.3 Operation Flow of Device]

[3.3.1 Operation Flow of UE 10B]

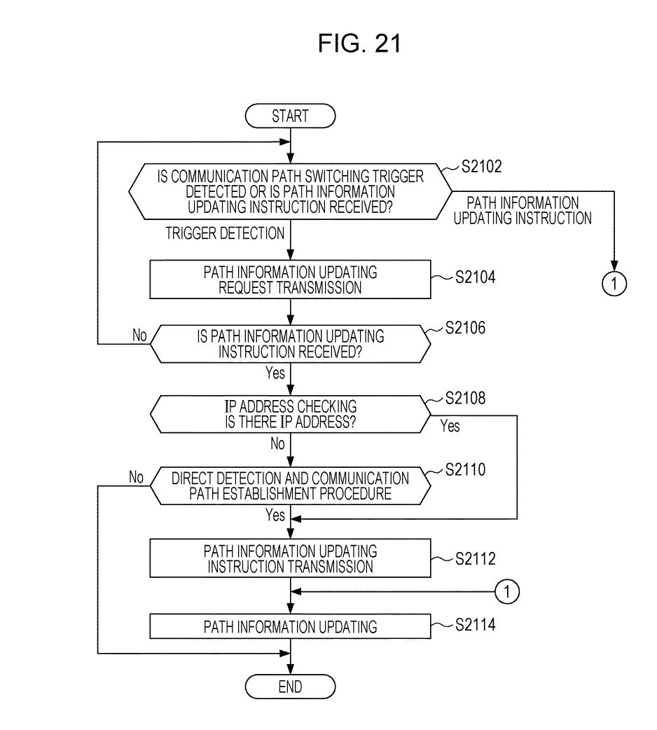

FIG. 21 shows an example of a flowchart of the UE 10B for realizing the sequence of FIG. 20. The flowchart of the UE 10A may be performed using the same flowchart as the flowchart of the UE 10B, and thus, the description thereof will be omitted.

The UE 10B detects the communication path switching trigger or waits to receive the path information updating instruction (step S2102). In a case where the UE 10B detects the communication path switching trigger (step S2102; trigger detection), the UE 10B transmits the path information updating request (including the indication flag 1) to the ProSe server 20 (step S2104).

Subsequently, the UE 10B waits to receive the path information updating instruction (including the indication flag 2) from the ProSe server 20 (step S2106). In a case where the UE is not able to receive the path information updating instruction (step S2106; No), the UE deems that the request is refused, and returns to step S2102.

In a case where the UE 10B receives the path information updating instruction from the ProSe server 20 in step S2106 (step S2108; Yes), the UE 10B checks the IP address used in the direct communication of the ProSe service with the UE 10A (step S2106).

In a case where the UE 10B does not retain the IP address used in the direct communication of the ProSe service (S2108; No), the UE 10B directly detects the UE 10A, and establishes the communication path of the direct communication (step S2110). In this case, in a case where UE is not able to establish the communication path of the direct communication (step S2110; No), the subsequent operations are not required, and thus, the process is completed.

In a case where the UE 10B establishes the communication path of the direct communication in step S2110 (step S2110; Yes) or in a case where the UE 10B previously retains the IP address used in the direct communication of the ProSe service in step S2108 (step S2108; Yes), the UE 10B transmits the path information updating instruction (including the indication flag 3) to the UE 10A (step S2112).

As the path information updating instruction of step S2112, the IP packet of the path information updating instruction received from the ProSe server 20 in step S2106 may be transmitted.

After the step S2112 is completed, or in a case where the path information updating instruction is received in step S2102 (step S2102; path information updating instruction), the UE 10B updates the communication with the UE 10A from the infrastructure communication to the direct communication (step S2114). In this case, the UE 10B may release the radio resource used in the direct communication via the core network. With this, the process is completed.

As described above, the UE 10A may determine to switch the communication between the UE 10A and the UE 10B to the direct communication using LTE, and may transmit the path information updating instruction to the ProSe server 20. The path information updating request may include at least the identification information (indication flag 1) indicating the request for the switching of the communication between the UE 10A and the UE 10B to the direct communication. The UE may request that the ProSe server 20 switches the communication between the UE 10A and the UE 10B to the direct communication.

The UE 10A may receive the path information updating instruction from the ProSe server 20. The path information updating instruction may include at least the identification information (indication flag 2) indicating the switching of the communication with the UE 10B to the direct communication. The UE may switch the communication with the UE 10B to the direct communication based on the indication flag 2.

The path information updating instruction may include the identification information (indication flag 2) for instructing that the UE 10B transmits the path information updating instruction. The UE 10A may transmit the path information updating instruction to the UE 10B based on the indication flag 2, and may cause the UE 10B to switch the communication with the UE 10A to the direct communication.

The UE 10A may receive the path information updating instruction from the UE 10B. The path information updating instruction may include at least the identification information (indication flag 3) instructing that the communication with the UE 10B is switched to the infrastructure communication. The UE may switch the communication with the UE 10B to the infrastructure communication based on the indication flag 3.

[3.3.2 Operation Flow of ProSe Server 20]

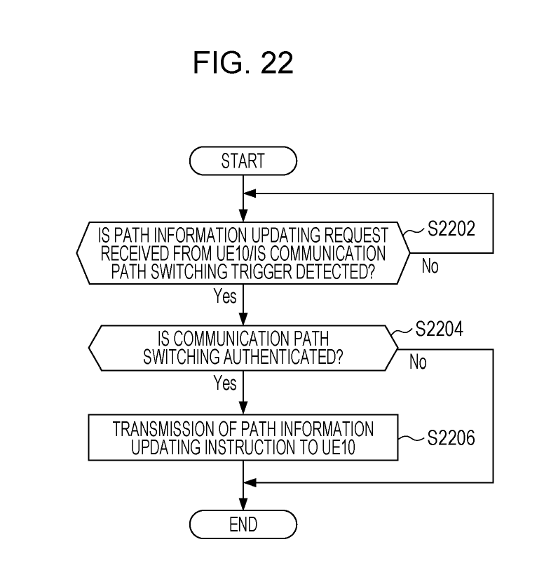

Hereinafter, FIG. 22 shows an example of a flowchart of the ProSe server 20 for realizing the sequence of FIG. 20.

The ProSe server 20 receives the path information updating request from the UE 10 (UE 10A or UE 10B), or waits for each terminal to detect the communication path switching trigger (step S2202).

In a case where the ProSe server 20 detects the communication path switching trigger or receives the path information updating request (step S2202; Yes), the ProSe server 20 determines whether or not to authenticate the updating of the communication path (step S2204).

The authentication determination method of the communication path switching of step S2204 may be performed based on whether or not the UE 10A and the UE 10B complete the service authentication by the ProSe Registration. For example, the ProSe server may perform the determination based on the authentication information such as the ProSe UE ID transmitted from the UE 10A and the UE 10B.

In a case where the ProSe server authenticates the communication path switching in step S2204 (step S2204; Yes), the ProSe server 20 transmits the path information updating instruction to the UE 10B (step S2206).

In a case where the ProSe server is not able to authenticate the communication path switching in step S2204 (step S2204; No) or after step S2206 is completed, the process is ended.

As described above, the ProSe server 20 may receive the path information updating request message from the UE 10B that performs the infrastructure communication via the core network with the UE 10A. The path information updating request message may include at least the identification information (indication flag 1) indicating the request for the switching of the communication between the UE 10A and the UE 10B from the infrastructure communication performed via the core network to the direct communication using LTE. The ProSe server may determine the communication path switching based on the identification information, may transmit the path information updating instruction which is the response to the path information updating request to any one UE of the UE 10A and the UE 10B, and may instruct any one UE to switch the communication with the other UE to the direct communication.

The ProSe server 20 may transmit the path information updating instruction to the UE 10A and may request that this UE transmits the path information updating instruction for instructing that the communication with the UE 10A is switched to the direct communication to the UE 10B. Similarly, the ProSe server may transmit the path information updating instruction to the UE 10B and may request that this UE transmits the path information updating instruction for instructing that the communication with the UE 10B is switched to the direct communication to the UE 10A.

The ProSe server 20 may determine to switch the communication between the UE 10A and the UE 10B from the infrastructure communication via the core network to the direct communication using LTE, may transmits the path information updating instruction to any one UE of the UE 10A and the UE 10B, and may switch the communication with the other UE to the direct communication.

The ProSe server may transmit the path information updating instruction to the UE 10A, and may request that this UE transmits the path information updating instruction for instructing that the communication with the UE 10A is switched to the direct communication to the UE 10B. Similarly, the ProSe server may transmit the path information updating instruction to the UE 10B, and may request that this UE transmits the path information updating instruction for instructing that the communication with the UE 10B is switched to the direct communication to the UE 10A.

In a case where the ProSe server 20 determines whether or not to switch the communication path between the UEs and authenticates the communication path switching even though the communication path switching trigger is detected, the ProSe server may transmit the path information updating instruction to only any one of the UE 10A and the UE 10B, and may switch the communication between the UEs from the infrastructure communication to the direct communication.

### 4. Fourth Embodiment

Hereinafter, a fourth embodiment will be described. The system structures according to the fourth embodiment and the third embodiment are the same, and thus, the process flow and the operation flow different from those of the third embodiment will be mainly described.

Although the embodiments related to the case where the communication between the UEs is switched from the direct communication to the infrastructure communication have been described in the first embodiment and the second embodiment, a method of switching the communication path of the communication between the UEs from the infrastructure communication to the direct communication will be described in the fourth embodiment, similarly to third embodiment.

Although the method in which the ProSe server transmits the path information updating instruction to any one UE, the UE that receives the path information updating instruction establishes the direct communication path with the communication partner and transmits the path information updating instruction to the communication partner, and the respective UEs update the path information has been described in the third embodiment, a method in which the ProSe server transmits the path information updating instruction to the respective UE and the respective UEs update the path information will be described in the fourth embodiment.

[4.1 Processing Example]

[4.1.1 Example of Communication Path Switching Procedure from Infrastructure Communication to Direct Communication]

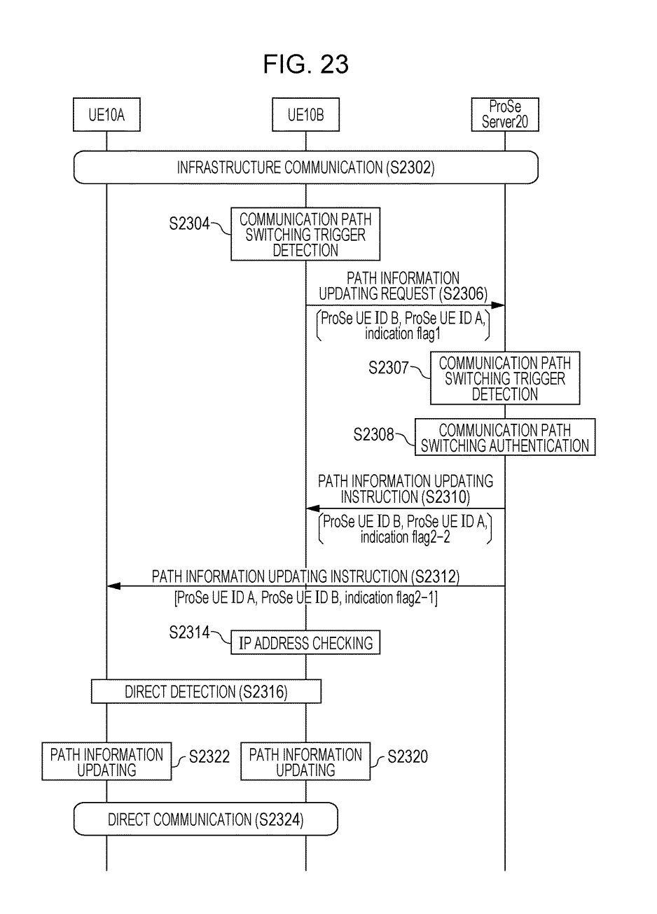

FIG. 23 is a conceptual diagram of the communication path switching, communication path switching and selection of the communication path performed in the present embodiment.

Although it has been described in the present embodiment that in a case where the respective functions desire to transmit the instruction or request of the operation to the communication partner, a flag such as indication flag is added, information indicating the request may be requested by transmitted a path information updating request message through the definition of the path information updating request message in addition to the identification method using the flag. More specifically, the devices that transmit the request or the instruction may transmit the request message including a message type for requesting path information updating to a requested partner.

In the process shown in FIG. 23, the indication flag is used as the following meanings.

indication flag 1: an information element which is included in a signal transmitted from the UE 10 (UE 10A or UE 10B) to the ProSe server 20 and indicates an instruction or a request.

indication flag 2-1: a first information element which is included in a signal transmitted to the UE 10 (UE 10A or UE 10B) from the ProSe server 20 and indicates an instruction or a request.

indication flag 2-2: a second information element which is included in a signal transmitted to the UE 10 (UE 10A or UE 10B) from the ProSe server 20 and indicates an instruction or a request.

Here, the function of the “indication flag 1” is executed using the same function as the function in the third embodiment, and thus, the detailed description thereof will be omitted.

The “indication flag 2-1” may be a flag indicating the request for the updating of the path information. For example, this indication flag may request that the switching or the updating the communication path from the infrastructure communication T1902 to the direct communication T1904 is performed.

That is, the ProSe server 20 transmits information including the “indication flag 2-1” to the UE 10A, and thus, the ProSe server 20 may update the path information of the UE 10A to the UE 10B. For example, the ProSe server may request that the UE 10A switches the communication path from the infrastructure communication to the direct communication.

The “indication flag 2-2” has the same function as that of the “indication flag 2-1”. That is, the ProSe server 20 transmits the information including the “indication flag 2-2” to the UE 10B, and thus, the ProSe server 20 may request that the UE 10B switches the communication path from the infrastructure communication to the direct communication.

The “indication flag 2-2” may request that the UE checks the IP address used in the direct communication of the ProSe service with the designated communication partner and performs the direct detection and the establishment process of the communication path by the checking result.

That is, the ProSe server 20 transmits the path information updating instruction including the “indication flag 2-2” to the UE 10B, and thus, the ProSe server 20 may request that the UE 10B checks the IP address used in the direct communication of the ProSe service with the UE 10A and performs the establishment procedure of the communication path of the direct communication by the checking result.

Initially, as the initial state, the UE 10A and the UE 10B perform the infrastructure communication (S2302). S2302 may be performed similarly to S1122, S1622, or S2002.

Subsequently, the UE 10B detects the communication path switching trigger (S2304). The trigger of S2304 is not particularly limited, and, for example, a case where it is detected that the UE 10B moves outside the coverage of the access network or the UE 10B is present in the proximity of the UE 10A is considered.

The UE 10B transmits the path information updating request to the ProSe server 20 by using s2004 as the trigger (S2306). The path information updating request of S2006 may include the identifier (for example, “ProSe UE ID B”) of the UE 10B, may include the identifier (for example, “ProSe UE ID A”) of the UE 10A, or may include the indication flag 1. Thereafter, the ProSe server 20 receives the path information updating request of S2306, and transmits the path information updating instruction to the UE 10A and the UE 10B based on the reception of the path information updating request.

As mentioned above, the ProSe server 20 may request that the UE 10A and the UE 10B update the path information based on the identification information of the UE included in the request message by receiving the path information updating request from the UE 10B.

Although the example in which the path information updating request of the UE 10B the ProSe UE ID A of the UE 10A as the information of the communication partner has been described, the present embodiment is not limited thereto, and the path information updating request may be group identification information indicating a group that performs communication. The ProSe server may acquire or retain the UE of the group identified by the group identification information, and may transmit the path information updating instruction to the UE of the group. The UE of the group may be plural in number.

Alternatively, the ProSe server 20 may detect the communication path switching trigger (S2307), and may transmit the path information updating instruction to the UE 10B as the detecting result.

The communication path switching trigger of the ProSe server 20 is not particularly designated, and, for example, a case where it is detected that the UEs are present in proximity to each other from the positional information of the UE stored in the UE positional information management table 226 of the storage unit 220 of the ProSe server 20 is considered. For example, in a case where it is determined that the UEs are sufficiently present in proximity to each other by the positional information, the ProSe server may transmit the path information updating instruction. In a case where it is determined that the UEs are not present in proximity to each other, the ProSe server may determine not to transmit the path information updating instruction.

When the path information updating instruction is transmitted, the ProSe server 20 may determine whether or not to authenticate the communication path switching (S2308), and may use the determining result as a condition in which the path information updating instruction is transmitted.

The authentication determination method of the communication path switching of S2308 may be performed based on whether or not the UE 10A and the UE 10B complete the service authentication by the ProSe Registration. For example, the ProSe server may perform the determination based on the authentication information such as the ProSe UE ID transmitted from the UE 10A and the UE 10B.

For example, in a case where the ProSe server 20 does not authenticate the communication path switching in S2308, the process is ended. The UE 10B detects that the request is refused based on the fact that there is no response. Before the ProSe server 20 ends the process, the ProSe server may transmit a refusal response to the UE 10B.

In a case where the ProSe server 20 authenticates the communication path switching in S2308, the ProSe server 20 transmits the path information updating instruction to the UE 10B and the UE 10A (S2310, S2312).

The path information updating instruction of S2310 and S2312 may include the identifier (for example, “ProSe UE ID B”) of the UE 10B, the identifier (for example, “ProSe UE ID A”) of the UE 10A, the indication flag 2-2 or the indication flag 2-1, or may add the plurality of these information elements to a plurality of path information updating instructions. In FIG. 23, it is assumed that the path information updating instruction addressed to the UE 10B includes the ProSe UE ID A, the ProSe UE ID B and the indication flag 2-2 and the path information updating instruction addressed to the UE 10A includes the ProSe UE ID A, the ProSe UE ID B and the indication flag 2-1.

The UE 10B may check the IP address used in the ProSe service based on the detection (S2314). In a case where the UE 10B does not store the IP address used in association with the ProSe service, the UE 10B directly detects the UE 10A (S2316).

As the specific method, the UE 10B transmits the request for the detection to the UE 10A and the UE 10A transmits the response to the UE 10B, so that the UE 10B may directly detect the UE 10A. In this case, the UE 10B may allocate the radio resource. Accordingly, this UE may establish the communication path of the direct communication.

As the checking result of S2314, in a case where the UE 10B retains the IP address used in the direct communication, or in a case where S2318 is completed, the UE 10B updates the path information of the communication with the UE 10A from the infrastructure communication to the direct communication (S2320).

The UE 10A updates the path information of the communication with the UE 10B from the infrastructure communication to the direct communication by using S2312 as the trigger (S2322).

By doing this, the UE 10A and the UE 10B perform the communication of the direct communication (S2324). S2324 may be performed similarly to S1102 or S2026.

As mentioned above, the UE 10 (UE 10A or UE 10B) detects the communication path switching trigger and the ProSe server 20 instructs that the respective UEs switch the communication path, so that the communication between the UE 10A and the UE 10B can be switched from the infrastructure communication to the direct communication.

The ProSe server 20 transmits the communication path switching instruction to the respective UEs even though the ProSe server 20 detects the communication path switching trigger of the communication between the UEs, and thus, the communication between the UEs can be switched from the infrastructure communication to the direct communication.

[4.2 Operation Flow of Device]

[4.2.1 Operation Flow of UE 10B]

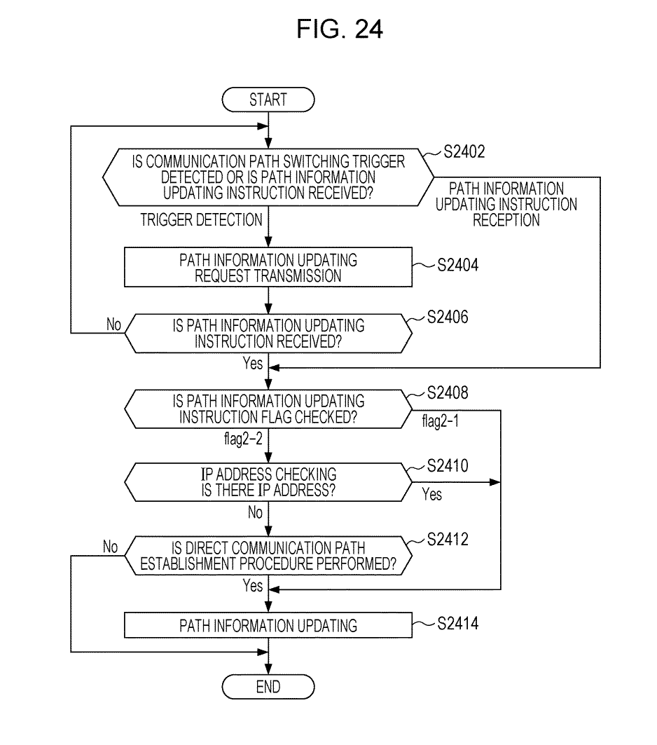

FIG. 24 shows an example of a flowchart of the UE 10B for realizing the sequence of FIG. 23. The flowchart of the UE 10A may be performed using the same flowchart as the flowchart of the UE 10B, and thus, the description thereof will be omitted.

The UE 10B detects the communication path switching trigger or waits to receive the path information updating instruction (step S2402). In a case where the UE 10B detects the communication path switching trigger (step S2402; trigger detection), the UE 10B transmits the path information updating request (including the indication flag 1) to the ProSe server 20 (step S2404).

Thereafter, the UE 10B checks whether or not the path information updating instruction is received from the ProSe server 20 (step S2406). In a case where the UE 10B is not able to receive the path information updating instruction from the ProSe server 20, the UE 10B deems that the request is refused, and returns to step S2402.

In a case where the path information updating instruction is received from the ProSe server 20 in step S2406 to step S2402 (step S2406; Yes or step S2402; path information updating instruction reception), the UE 10B checks the type of request or the “indication flag” included in the signal (step S2408).

In a case where the path information updating instruction received by the UE 10B includes the indication flag 2-2 (step S2408; flag 2-2), the UE 10B checks the IP address used in the direct communication of the ProSe service with the UE 10A (step S2410).

In a case where the UE 10B does not retain the IP address used in the direct communication of the ProSe service (step S2410; No), the UE 10B directly detects the UE 10A, and starts the establishment procedure of the communication path of the communication path of the direct communication (step S2412). Here, in a case where the communication path of the direct communication is not able to be established (step S2412; No), the process is ended.

In a case where the communication path of the direct communication is established in step S2412 (step S2412; Yes), in a case where the signal received by the UE 10B includes the “indication flag 2-1” in step S2408 (step S2408; flag 2-1), or in a case where the UE 10B previously retains the IP address used in the direct communication of the ProSe service in step S2410, the UE 10B updates the path information of the communication with the UE 10A from the infrastructure communication to the direct communication (step S2414). In this case, the UE 10B may release the radio resource used in the direct communication via the core network. By doing this, the flow of the UE 10B is ended.

As described above, the UE 10B autonomously detects the communication path switching trigger, so that the UE 10B may transmit the path information updating request to the ProSe server 20, may update the path information of the communication with the UE 10A based on the path information updating instruction received from the ProSe server, and may switch the communication between the UEs from the infrastructure communication to the direct communication.

Even though the UE 10B does not detect the communication path switching trigger, the UE 10B receives the path information updating instruction from the ProSe server 20, so that the UE may update the path information of the communication with the UE 10A, and may switch the communication between the UEs from the infrastructure communication to the direct communication.

The UE 10B can identify the instruction included in the received path information updating instruction, and can perform the direct communication path establishment procedure before the path information is updated according to some instruction.

[4.2.2 Operation Flow of ProSe Server 20]

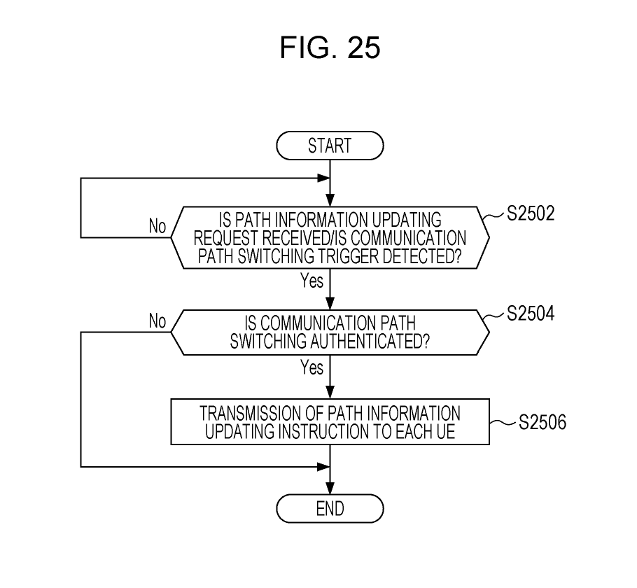

Hereinafter, FIG. 25 shows an example of a flowchart of the ProSe server 20 for realizing the sequence of FIG. 23.

The ProSe server 20 receives the path information updating request from the UE 10 (UE 10A or UE 10B), or waits for each terminal to detect the communication path switching trigger (step S2502).

In a case where the ProSe server 20 detects the communication path switching trigger or receives the path information updating request (step S2502; Yes), the ProSe server 20 determines whether or not to authenticate the updating of the communication path (step S2504).

The authentication determination method of the communication path switching of step S2504 may be performed based on whether or not the UE 10A and the UE 10B complete the service authentication by the ProSe Registration. For example, the ProSe server may perform the determination based on the authentication information such as the ProSe UE ID transmitted from the UE 10A and the UE 10B.

In a case where the communication path switching is authenticated in step S2504 (step S2504; Yes), the ProSe server 20 transmits the path information updating instruction to the UE 10 (UE 10A or UE 10B) (step S2506).

In a case where the communication path switching is not able to be authenticated in step S2504 (step S2504; No) or after step S2506 is completed, the process is ended.

With this, the ProSe server 20 may transmit the path information updating instruction to the UE 10A and the UE 10B, may instruct that the UE 10A switches the communication with the UE 10B to the direct communication, and may instruct that the UE 10B switches the communication with the UE 10A to the direct communication.

In a case where the ProSe server 20 determines whether or not to switch the communication path switching and authenticates the communication path switching even though the ProSe server 20 autonomously detects the communication path switching trigger, the ProSe server transmits the path information updating instruction to both of the UE 10A and the UE 10B, instructs that the UE 10A switches the communication with the UE 10B to the direct communication, and instructs that the terminal device of the UE 10B switches the communication with the UE 10A to the direct communication.

### 5. Fifth Embodiment

Hereinafter, a fifth embodiment will be described. The system structures according to the fifth embodiment and the third embodiment are the same, and thus, the process flow and the operation flow different from those of the third embodiment will be mainly described.

Although the embodiments related to the case where the communication between the UEs is switched from the direct communication to the infrastructure communication have been described in the first embodiment and the second embodiment, a method of switching the communication path of the communication between the UEs from the infrastructure communication to the direct communication will be described in the fifth embodiment, similarly to third embodiment or the fourth embodiment.

Although the method in which the UE receives the path information updating from the ProSe server, establishes the direct communication path and updates the path information has been described in the third embodiment and the fourth embodiment, a method in which the UE establishes the direct communication path before the path information updating instruction from the ProSe server will be described in the fifth embodiment.

[5.1 Processing Example]

[5.1.1 Example of Communication Path Switching Procedure from Infrastructure Communication to Direct Communication]

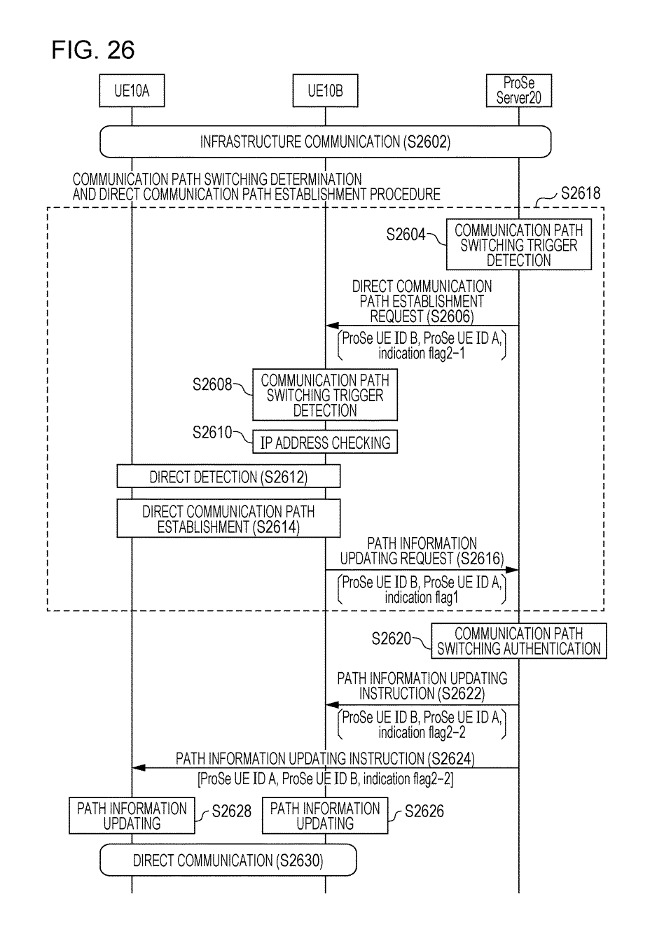

FIG. 26 is a conceptual diagram of the communication path switching, communication path switching and selection of the communication path performed in the present embodiment.

Although it has been described in the present embodiment that in a case where the respective functions desire to transmit the instruction or request of the operation to the communication partner, a flag such as indication flag is added, information indicating the request may be requested by transmitted a path information updating request message through the definition of the path information updating request message in addition to the identification method using the flag. More specifically, the devices that transmit the request or the instruction may transmit the request message including a message type for requesting path information updating to a requested partner.

In the process shown in FIG. 26, the indication flag is used as the following meanings.

indication flag 1: a first information element which is included in a signal transmitted from the UE 10 (UE 10A or UE 10B) to the ProSe server 20 and indicates an instruction or a request.

indication flag 2-1: a first information element which is included in a signal transmitted to the UE 10 (UE 10A or UE 10B) from the ProSe server 20 and indicates an instruction or a request.

indication flag 2-2: a second information element which is included in a signal transmitted to the UE 10 (UE 10A or UE 10B) from the ProSe server 20 and indicates an instruction or a request.

Here, the function of the “indication flag 1” is executed using the same function as the function in the third embodiment, and thus, the detailed description thereof will be omitted.

The “indication flag 2-1” may check the IP address used in the direct communication of the ProSe service with the designated communication partner, may instruct that the communication path is established by the checking result if necessary, and may instruct that information indicating that the establishment and checking of the direct communication path are completed is notified to the ProSe server 20.

That is, the ProSe server 20 transmits the path information updating instruction including the “indication flag 2-1” to the UE 10B, and thus, the ProSe server 20 may request that the UE 10B checks the IP address used in the direct communication of the ProSe service with the UE 10A, performs the establishment process of the communication path by the checking result and performs the notification after the establishment.

The “indication flag 2-2” may request the switching or updating of the communication path from the infrastructure communication T1902 to the direct communication T1904.

That is, the ProSe server 20 transmits the information including the “indication flag 2-2” to the UE 10A, and thus, the ProSe server 20 may request that the UE 10A switches the communication path from the infrastructure communication to the direct communication.

Initially, as an initial state of FIG. 26, the UE 10A and the UE 10B perform the infrastructure communication as (S2602). S2602 may be performed similarly to S2002, S1122, S1622 or S2002.

Subsequently, the ProSe server 20 detects the communication path switching trigger (S2604). The communication path switching trigger of the ProSe server 20 is not particularly designated, and, for example, a case where it is detected that the UEs are present in proximity to each other from the positional information of the UE stored in the UE positional information management table 226 of the storage unit 220 of the ProSe server 20 is considered.

The ProSe server 20 transmits the direct communication path establishment request to the UE 10 (UE 10A or UE 10B) by using S2604 as the trigger (S2606). In FIG. 26, the ProSe server 20 transmits the direct communication path establishment request to the UE 10B. The determination method of the transmission destination UE is not particularly limited. For example, the UE present closest to the center of the coverage of the access network of LTE may be selected.

The direct communication path establishment request of S2606 may include the identifier (for example, “ProSe UE ID B”) of the UE 10B, the identifier (for example, “ProSe UE ID A”) of the UE 10A, the indication flag 2-2 or the indication flag 2-1, or may add the plurality of these information elements to a plurality of path information updating instructions.

Thereafter, the UE 10B checks that the direct communication path establishment request received from the ProSe server 20 includes the indication flag 2 (S2606), and checks the IP address of the UE 10B based on the request.

As stated above, the UE 10B may check the IP address of the UE 10B by receiving the direct communication path establishment request from the ProSe server 20.

Although the example in which the direct communication path establishment request of the ProSe server 20 includes the ProSe UE ID A of the UE 10A as the information of the communication partner has been described, the present embodiment is not limited thereto, and the direct communication path establishment request may include group identification information indicating a group that performs communication. The ProSe server may acquire or retain the UE of the group identified by the group identification information, and may transmit the path information updating instruction to the UE of the group. The UE of the group may be plural in number.

Alternatively, the UE 10B may autonomously detect the communication path switching trigger (S2608), and may check whether or not to the IP address used in the direct communication with the UE 10A is retained (S2610).

In a case where the IP address used in the direct communication is not retained as the result of S2610, the UE 10B directly detects the UE 10A (S2612).

As the specific method, the UE 10B transmits the request for the detection to the UE 10A and the UE 10A transmits the response to the UE 10B, so that the UE 10B may directly detect the UE 10A. In this case, the UE 10B may allocate the radio resource. Accordingly, this UE may establish the communication path of the direct communication.

If the establishment of the communication path for the direct communication between the UE 10A and the UE 10B is completed, or in a case where the UE 10B retains the IP address used in the direct communication as the checking result of S2610, the UE 10B transmits the path information updating request to the ProSe server 20 (S2616). The path information updating request of S2616 may include the identifier (for example, “ProSe UE ID B”) of the UE 10B, may include the identifier (for example, “ProSe UE ID A”) of the UE 10A, or may include the indication flag 1.

The procedures of S2604 to S2616 correspond to the communication path switching determination and direct communication path establishment procedure (S2618).

The ProSe server 20 receives the path information updating request including the indication flag 1 from the UE 10B, and transmits the path information updating instruction to the UE 10A and the UE 10B.

As mentioned above, the ProSe server 20 may request that the UE 10A and the UE 10B update the path information based on the identification information of the UE included in the request message by receiving the path information updating request from the UE 10B.

Although the example in which the path information updating request of the UE 10B the ProSe UE ID A of the UE 10A as the information of the communication partner has been described, the present embodiment is not limited thereto, and the path information updating request may be group identification information indicating a group that performs communication. The ProSe server may acquire or retain the UE of the group identified by the group identification information, and may transmit the path information updating instruction to the UE of the group. The UE of the group may be plural in number.

When the path information updating instruction is transmitted, the ProSe server 20 may determine whether or not to authenticate the communication path switching (S2308), and may use the determining result as a condition in which the path information updating instruction is transmitted.

The authentication determination method of the communication path switching of S2620 may be performed based on whether or not the UE 10A and the UE 10B complete the service authentication by the ProSe Registration. For example, the ProSe server may perform the determination based on the authentication information such as the ProSe UE ID transmitted from the UE 10A and the UE 10B.

For example, in a case where the ProSe server 20 does not authenticate the communication path switching in S2620, the process is ended. The UE 10B detects that the request is refused based on the fact that there is no response. Before the ProSe server 20 ends the process, the ProSe server may transmit a refusal response to the UE 10B.

In a case where the ProSe server 20 authenticates the communication path switching in S2620, the ProSe server 20 transmits the path information updating instruction to the UE 10A and the UE 10B (S2622 and S2624).

The path information updating instruction of S2622 or S2624 may include the identifier (for example, “ProSe UE ID B”) of the UE 10B, the identifier (for example, “ProSe UE ID A”) of the UE 10A, or the indication flag 2-2, or may add the plurality of these information elements to a plurality of path information updating instructions. In FIG. 23, it is assumed that the path information updating instruction includes all the information elements.

The UE 10B and the UE 10A receive the path information updating instruction from the ProSe server 20, and switch the path information from the infrastructure communication to the direct communication if the path information updating instruction includes the indication flag 2-2 (S2626 and S2628).

By doing this, the UE 10A and the UE 10B start the communication through the direct communication (S2630). S2630 may be performed similarly to S2324, S1102 or S2026.

As described above, after the UE 10A and the UE 10B previously establish the communication path of the switching destination, the ProSe server 20 determines the communication path switching from the infrastructure communication to the direct communication by authenticating the communication path switching and transmitting the path information updating instruction to the respective UEs.

[5.2 Operation Flow of Device]

[5.2.1 Operation Flow of UE 10B]

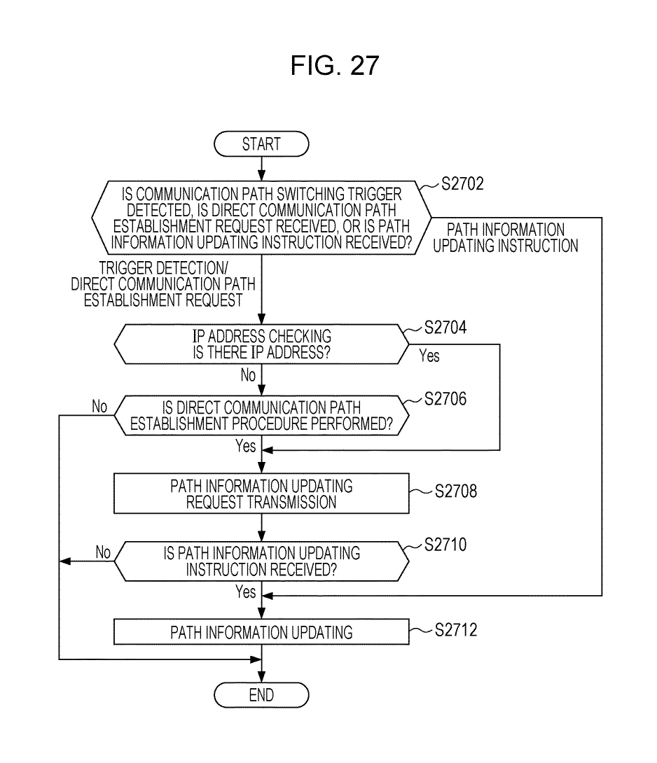

FIG. 27 shows an example of a flowchart of the UE 10B for realizing the sequence of FIG. 26. The flowchart of the UE 10A may be performed using the same flowchart as the flowchart of the UE 10B, and thus, the description thereof will be omitted.

The UE 10B detects the communication path switching trigger, or waits to receive the direct communication path establishment request (including the indication flag 2-1) from the ProSe server 20, or waits to receive the path information updating instruction (including the indication flag 2-1) from the ProSe server 20 (step S2702).

If the UE 10B detects the trigger or checks the reception of the direct communication path establishment in step S2702 (step S2702; trigger detection/direct communication path establishment request), the UE 10B checks the IP address used in the direct communication of the ProSe service with the UE 10A (step S2704).

In a case where the UE 10B does not retain the IP address used in the direct communication of the ProSe service as the checking result of step S2706 (step S2704; No), the UE 10B starts the communication path establishment procedure for the direct communication with the UE 10A (step S2706). In a case where the establishment of the communication path fails (step S2706; No), the UE 10B ends the process.

In a case where the communication path is not able to be established in step S2706 (step S2706; Yes) or in a case where the UE 10B previously retains the IP address used in the direct communication of the ProSe service (step S2704; Yes), the UE 10B transmits the path information updating request to the ProSe server 20 (step S2708).

Thereafter, the UE 10B waits to receive the path information updating instruction from the ProSe server (step S2710). Here, in a case where the UE is not able to receive the path information updating instruction from the ProSe server 20 (step S2710; No), the UE 10B ends the process.

In a case where the path information updating instruction (including the indication flag 2-1) is received from the ProSe server 20 in step S2710 or step S2702 (step S2710; Yes or step S2702; path information updating instruction), the UE 10B updates the path information from the infrastructure communication to the direct communication (step S2712). In this case, the UE 10B may release the radio resource used in the direct communication via the core network.

As stated above, the UE 10B autonomously detects the communication path switching trigger, and thus, the UE 10B can establish the direct communication path with the communication partner.

The UE 10B may receive the direct communication path establishment request from the ProSe server 20. The direct communication path establishment request may include at least the identification information (indication flag 2-1) indicating the request for the checking and establishment of the establishment state of the direct communication path with the UE 10A. The UE may check and establish the establishment state of the direct communication path with the UE 10A based on the indication flag 2-1.

If the direct communication path with the UE 10A is established, the UE 10B can transmit the path information updating request to the ProSe server 20, and can switch the communication with the UE 10A from the infrastructure communication to the direct communication by receiving the path information updating instruction from the ProSe server 20 and updating the path information.

[5.2.2 Operation Flow of ProSe Server 20]

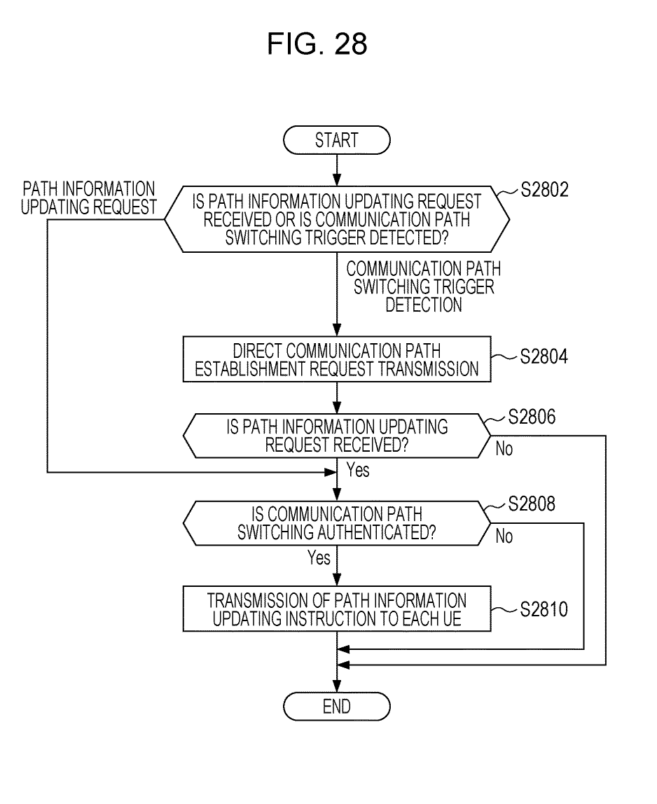

Hereinafter, FIG. 28 shows an example of a flowchart of the ProSe server 20 for realizing the sequence of FIG. 26.

The ProSe server 20 receives the path information updating request (including the indication flag 1) from the UE 10 (UE 10A or UE 10B), or waits for each terminal to detect the communication path switching trigger (step S2802).

In a case where the ProSe server 20 detects the communication path switching trigger (step S2802; communication path switching trigger detection), the ProSe server 20 transmits the direct communication path establishment request (including the indication flag 2-1) to the UE 10 (UE 10A or UE 10B) (step S2804).

Subsequently, the ProSe server 20 waits to receive the path information updating request from the UE 10 (UE 10A or UE 10B) (step S2806).

In a case where the path information updating request (including the indication flag 1) is received from the UE 10 (UE 10A or UE 10B) in step S2802 or step S2806 (step S2802; path information updating request or step S2806; Yes), the ProSe server 20 determines whether or not to authenticate the communication path switching (step S2808).

In a case where the path information updating request is not received in step S2806 (step S2806; No), the ProSe server 20 may end this process.

The authentication determination method of the communication path switching of step S2808 may be performed based on whether or not the UE 10A and the UE 10B complete the service authentication by the ProSe Registration. For example, the ProSe server may perform the determination based on the authentication information such as the ProSe UE ID transmitted from the UE 10A and the UE 10B.

In a case where the communication path switching is not able to be authenticated in step S2808 (step S2808), the ProSe server 20 ends the process. However, the ProSe server 20 may transmit a signal for notifying the UE 10B of the fail before the process is ended.

If the ProSe server 20 completes the authentication of the communication path switching in step S2808, the ProSe server 20 transmits the path information updating instruction (indication flag 2-2) to the respective UEs (UE 10A and UE 10B) (step S2810).

As mentioned above, in a case where the ProSe server 20 determines the communication path switching and authenticates the communication path switching by receiving the path information updating request from the UE 10A or the UE 10B, the ProSe server can transmit the path information updating instruction to both of the UE 10A and the UE 10B.

The ProSe server 20 may determine to switch the communication between the UE 10A and the UE 10B from the infrastructure communication to the direct communication, may transmit the direct communication path establishment request message to the UE 10B, and may instruct that the direct communication path with the UE 10A are checked and established.

In a case where the ProSe server determines to switch the communication path switching and authenticates the communication path switching by receiving the path information updating request from the UE 10A or the UE 10B, the ProSe server may transmit the path information updating instruction to both of the UE 10A and the UE 10B. Accordingly, the ProSe server 20 may switch the communication between the UEs from the infrastructure communication to the direct communication.

### 6. Sixth Embodiment

Hereinafter, a sixth embodiment will be described. The system structures according to the sixth embodiment and the fifth embodiment are the same, and thus, the process flow and the operation flow different from those of the fifth embodiment will be mainly described.

Although the embodiments related to the case where the communication between the UEs is switched from the direct communication to the infrastructure communication have been described in the first embodiment and the second embodiment, a method of switching the communication path of the communication between the UEs from the infrastructure communication to the direct communication will be described in the sixth embodiment, similarly to third embodiment, the fourth embodiment or the fifth embodiment.

Although the method in which the UE receives the path information updating from the ProSe server, establishes the direct communication path and updates the path information has been described in the third embodiment and the fourth embodiment, a method in which the UE establishes the direct communication path before the path information updating instruction from the ProSe server will be described in the sixth embodiment similarly to the fifth embodiment. Although the method in which the ProSe server transmits the path information updating instruction to the respective UEs has been described in the fifth embodiment, a method in which the ProSe server transmits the path information to only any one UE of two UEs and the UE that receives the path information updating instruction transmits the path information updating instruction to the communication partner will be described in the sixth embodiment.

[6.1 Processing Example]

[6.1.1 Example of Communication Path Switching Procedure from Infrastructure Communication to Direct Communication]

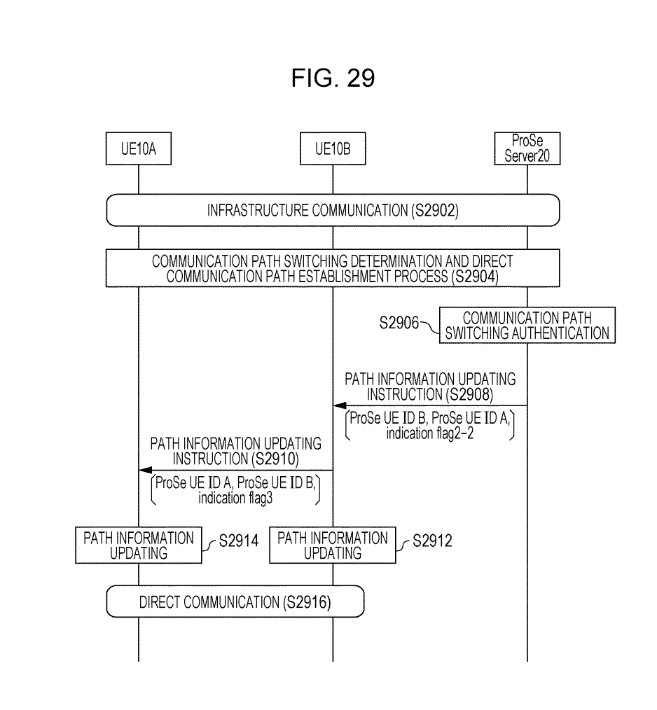

FIG. 29 is a conceptual diagram of the communication path switching, communication path switching and selection of the communication path performed in the present embodiment.

Although it has been described in the present embodiment that in a case where the respective functions desire to transmit the instruction or request of the operation to the communication partner, a flag such as indication flag is added, information indicating the request may be requested by transmitted a path information updating request message through the definition of the path information updating request message in addition to the identification method using the flag. More specifically, the devices that transmit the request or the instruction may transmit the request message including a message type for requesting path information updating to a requested partner.

In the process shown in FIG. 29, the indication flag is used as the following meanings.

indication flag 1: a first information element which is included in a signal transmitted from the UE 10 (UE 10A or UE 10B) from the ProSe server 20 and indicates an instruction or a request.

indication flag 2-1: first information element which is included in a signal transmitted to the UE 10 (UE 10A or UE 10B) from the ProSe server 20 and indicates an instruction or a request.

indication flag 2-2: a second information element which is included in a signal transmitted to the UE 10 (UE 10A or UE 10B) from the ProSe server 20 and indicates an instruction or a request.

indication flag 3: an information element which is included in a signal transmitted from the UE 10A to the UE 10B or a signal transmitted from the UE 10B to the UE 10A and indicates an instruction or a request.

The functions of the “indication flag 1” and the “indication flag 2-1” are the same as those in the fifth embodiment, and the function of the “indication flag 3” is the same as the function of the “indication flag 3” of the second embodiment, and thus, the detailed description thereof will be omitted. For example, this indication flag may request that the path information is changed from the infrastructure communication to the direct communication.

The “indication flag 2-2” may request the switching or updating of the communication path from the infrastructure communication T1902 to the direct communication T1904.

That is, the ProSe server 20 transmits the information including the “indication flag 2-2” to the UE 10B, and thus, the ProSe server 20 may request that the UE 10B switches the communication path from the infrastructure communication to the direct communication.

The “indication flag 2-2” may be a request for instructing that the UE transmits the signal for instructing the path information updating to the communication partner.

That is, the ProSe server 20 transmits the information including the “indication flag 2-2” to the UE 10B, and thus, the ProSe server 20 may request that the UE 10B transmits the signal including the path information updating instruction to the UE 10A.

Initially, as an initial state of FIG. 29, the UE 10A and the UE 10B perform the infrastructure communication as (S2902). S2902 may be performed similarly to S2602, S2002, S1122, S1622 or S2002.

Subsequently, the “communication path switching determination and direct communication path establishment procedure” S2904 in which the ProSe server 20 or the UE 10A or the UE 10B detects the communication path switching trigger, so that the communication path between the UE 10A and the UE 10B is established and the path information updating request is transmitted to the ProSe server 20 from the UE 10A or the UE 10B is performed. S2904 may be performed using the same procedure as that of S2618.

The ProSe server 20 receives the path information updating request including the indication flag 1, and transmits the path information updating instruction to the UE 10A or the UE 10B.

As mentioned above, the ProSe server 20 may request that the UE 10B updates the path information together with the identification information of the UE included in the request message by receiving the path information updating request from the UE 10A or the UE 10B.

When the path information updating instruction is transmitted, the ProSe server 20 may determine whether or not to authenticate the communication path switching (S2906), and may use the determining result as a condition in which the path information updating instruction is transmitted.

The authentication determination method of the communication path switching of S2906 may be performed based on whether or not the UE 10A and the UE 10B complete the service authentication by the ProSe Registration. For example, the ProSe server may perform the determination based on the authentication information such as the ProSe UE ID transmitted from the UE 10A and the UE 10B.

For example, in a case where the ProSe server 20 does not authenticate the communication path switching in S2906, the process is ended. The UE 10B detects that the request is refused based on the fact that there is no response. Before the ProSe server 20 ends the process, the ProSe server may transmit a refusal response to the UE 10B.

In a case where the ProSe server 20 authenticates the communication path switching in S2906, the ProSe server 20 transmits the path information updating instruction to the UE 10 (UE 10A or UE 10B) (S2908). In FIG. 29, the ProSe server 20 transmits the path information updating instruction to the UE 10B. The determination method of the transmission destination UE is not particularly limited. For example, the UE present closest to the center of the coverage of the access network of LTE may be selected.

The path information updating instruction of S2906 may include the identifier (for example, “ProSe UE ID B”) of the UE 10B, the identifier (for example, “ProSe UE ID A”) of the UE 10A, or the indication flag 2-2, or may add the plurality of these information elements to a plurality of path information updating instructions.

The indication flag 2-2 is included in the path information updating instruction received by the UE 10B from the ProSe server 20, and thus, the UE 10B transmits the path information updating instruction to the UE 10A (S2910).

The path information updating instruction of S2910 may include the identifier (for example, “ProSe UE ID B”) of the UE 10B, the identifier (for example, “ProSe UE ID A”) of the UE 10A, or the indication flag 3, or may add the plurality of these information elements to a plurality of path information updating instructions.

The indication flag 2-2 is included in the path information updating instruction of S2908 or the path information updating instruction of S2910 is transmitted, and thus, the UE 10B updates the path information with the UE 10A stored in the path information table 142 of the UE 10B from the “infrastructure communication” to the “direct communication” (S2912).

The indication flag 3 is included in the path information updating instruction of S2910, and thus, the UE 10A updates the path information with the UE 10B stored in the path information table 142 of the UE 10A from the “infrastructure communication” to the “direct communication” (S2914). By doing this, the UE 10A and the UE 10B starts the direct communication (S2916).

As described above, after the UE 10A and the UE 10B previously establish the communication path of the switching destination, the ProSe server 20 determines the communication path switching from the infrastructure communication to the direct communication by authenticating the communication path switching and transmitting the path information updating instruction to any one UE of the UE 10A and the UE 10B.

[6.2 Operation Flow of Device]

[6.2.1 Operation Flow of UE 10B]

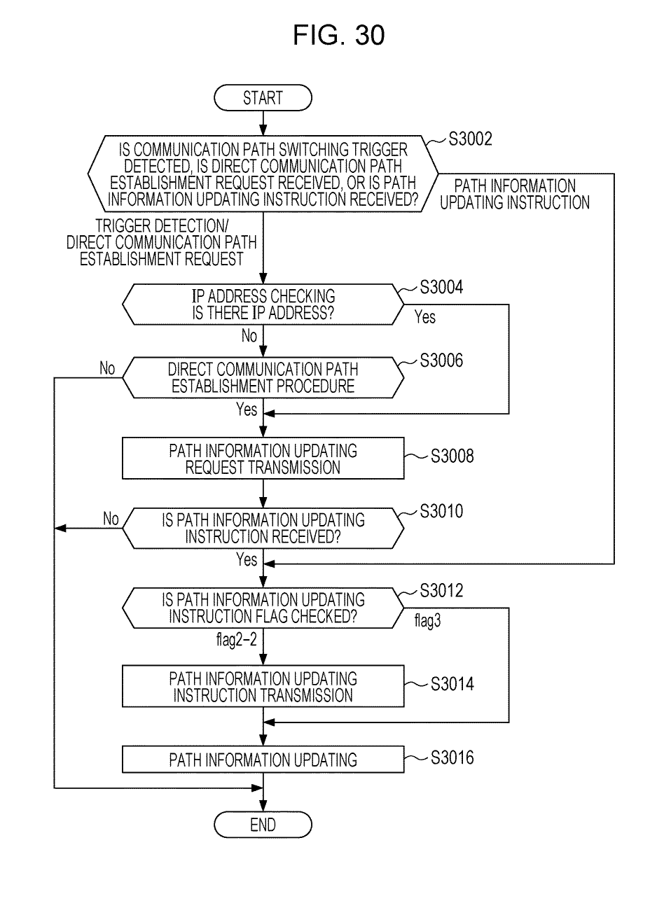

FIG. 30 shows an example of a flowchart of the UE 10B for realizing the sequence of FIG. 29. The flowchart of the UE 10A may be performed using the same flowchart as the flowchart of the UE 10B, and thus, the description thereof will be omitted.

The steps from the step (step S3002) of causing the UE 10B to detect the communication path switching trigger, receive the direct communication path establishment request (including the indication flag 2-1) from the ProSe server 20 or wait to receive the path information updating instruction (including the indication flag 2-1) from the ProSe server 20 to the step (step S3010) of causing the UE 10B to receive the path information updating instruction are performed using the same procedures as step S2702 to step S2710 of FIG. 27, and thus, the detailed description thereof will be omitted.

In a case where the UE 10B receives the path information updating instruction in step S3010 or step S3002 (step S3010; Yes or step S3002; path information updating instruction), the UE 10B checks the request or the indication flag included in the received path information updating instruction (step S3012).

In a case where the path information updating instruction received by the UE 10B includes the indication flag 2-2 (step S3012; flag 2-2), the UE 10B transmits the path information updating instruction (including the indication flag 3) to the UE 10A (step S3014).

Thereafter, in a case where the path information updating instruction received by the UE 10B includes the indication flag 3, the UE 10B updates the path information from the “infrastructure communication” to the “direct communication” (step S3016). In this case, the UE 10B may release the radio resource used in the direct communication via the core network. With this, the UE 10B ends the process.

As stated above, the UE 10B autonomously detects the communication path switching trigger, and thus, the UE 10B can establish the direct communication path with the communication partner. The UE 10B can establish the direct communication path with the UE 10A by receiving the direct communication path establishment request from the ProSe server 20.

If the direct communication path with the UE 10A is established, the UE 10B can transmits the path information updating request to the ProSe server 20, and can switch the communication path of the communication with the UE 10A from the infrastructure communication to the direct communication by receiving the path information updating instruction from the ProSe server 20 or the UE 10A and updating the path information.

The UE 10B identifies the instruction included in the received path information updating instruction and the UE 10A transmits the path information updating instruction, so that the communication between the UEs can be switched from the infrastructure communication to the direct communication.

[6.2.2 Operation Flow of ProSe Server 20]

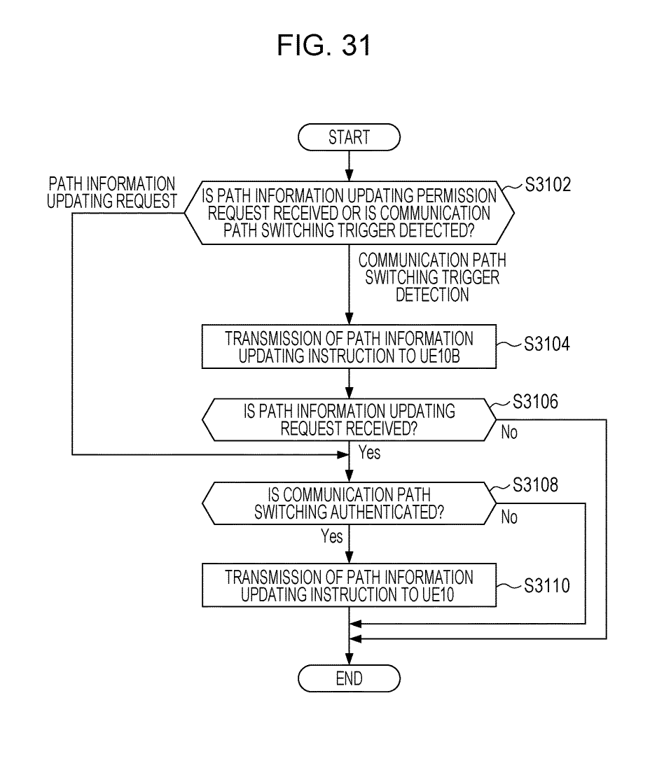

Hereinafter, FIG. 31 shows an example of a flowchart of the ProSe server 20 for realizing the sequence of FIG. 29.

The steps from the step (step S3102) of causing the ProSe server 20 to receive the path information updating request (including the indication flag 1) from the UE 10 (UE 10A or UE 10B) or causing each terminal to detect the communication path switching trigger to the step (step S3108) of causing the ProSe server to determine whether or not to authenticate the communication path switching are the same as the step S2802 to step S2808 of the fifth embodiment, and thus, the detailed description thereof will be omitted.

In a case where the ProSe server 20 authenticates the communication path switching in step S3108 (step S3108; Yes), the ProSe server 20 transmits the path information updating instruction (including the indication flag 2-2) to the UE 10 (UE 10A or UE 10B) (step S3110).

In a case where the ProSe server does not authenticate the communication path switching in step S3108 (step S3108), the ProSe server ends the process without transmitting any information. In this case, before the process is ended, the ProSe server may notify the terminal that transmits the path information updating request in step S3106 of the reason of the path information updating permission.

As mentioned above, in a case where the ProSe server 20 determines whether or not to switch the communication path and authenticates the communication path switching by receiving the path information updating request from the UE 10A or the UE 10B, the ProSe server can switch the communication between the UEs from the infrastructure communication to the direct communication by transmitting the path information updating instruction to any one of the UE 10A and the UE 10B.

In a case where the ProSe server requests that the UE 10A or the UE 10B requests the direct communication path establishment by autonomously detecting the communication path switching trigger, and determines whether or not to switch the communication path and authenticates the communication path switching by receiving the path information updating request from the UE 10A or the UE 10B, the ProSe server 20 can switch the communication between the UEs from the infrastructure communication to the direct communication by transmitting the path information updating instruction to any one of the UE 10A and the UE 10B.

### REFERENCE SIGNS LIST

1 Wireless communication system
3 IP mobile communication network
9 Core network
10, 10A, 10B, 10C UE
20 ProSe server
100 Control unit
110 First transmission and reception unit
112 Transmit and receive antenna
120 Second transmission and reception unit
122 Transmit and receive antenna
130 Storage unit
132 ProSe UE ID management table
134 IP address management table
136 Outer IP address management table
138 ECM state table
142 Path information table
144 In coverage flag
200 Control unit
210 Communication unit
220 Storage unit
222 ProSe UE ID management table
224 In coverage flag
226 UE positional information management table

1. A server device adapted to:
transmit a first request message including first identification information to a second terminal device that performs direct communication using LTE with a first terminal device, the first identification information indicating a request for switching of communication between the terminal devices from the direct communication using LTE to infrastructure communication performed via a core network.

2. The server device according to claim 1,
wherein the first identification information indicates a request for the switching of the communication between the terminal devices from the direct communication using LTE to the infrastructure communication performed via the core network and for transmission of a request message for the switching of the communication between the terminal devices from the direct communication using LTE to the infrastructure communication performed via the core network to the first terminal device.

3. A server device adapted to:
transmit a first request message including first identification information to a second terminal device that performs direct communication using LTE with a first terminal device, the first identification information indicating a request for switching of communication between the terminal devices from the direct communication using LTE to infrastructure communication performed via a core network; and
transmit a second request message including second identification information to the first terminal device, the second identification information indicating the request for the switching of the communication between the terminal devices from the direct communication using LTE to the infrastructure communication performed via the core network.

4. The server device according to claim 1,
wherein the server device is adapted to receive a third request message which includes third identification information and is transmitted from the second terminal device,
the third identification information indicates the request for the switching of the communication between the terminal devices from the direct communication using LTE to the infrastructure communication performed via the core network, and
the server device is adapted to transmit the first request message based on the reception of the third request message.

5. The server device according to claim 3,
wherein the server device is adapted to receive a third request message which includes third identification information and is transmitted from the second terminal device,
the third identification information indicates the request for the switching of the communication between the terminal devices from the direct communication using LTE to the infrastructure communication performed via the core network, and
the server device is adapted to transmit the first request message and/or the second request message based on the reception of the third request message.

6. A terminal device that performs direct communication using LTE with another terminal device, the terminal device adapted to:
receive a first request message including first identification information from a server device, the first identification information indicating a request for switching of communication between the terminal devices from direct communication using LTE to infrastructure communication performed via a core network; and
switch from the direct communication using LTE to the infrastructure communication performed via the core network to continue the communication with the other terminal device, based on the reception of the first request message.

7. The terminal device according to claim 6,
wherein the terminal device is adapted to transmit a third request message including third identification information to the server device,
the third identification information indicates the request for the switching of the communication between the terminal devices from the direct communication using LTE to the infrastructure communication performed via the core network, and
the terminal device is adapted to receive the other request message as a response to the third request message.

8. The terminal device according to claim 6,
wherein the terminal device is adapted to transmit a second request message including second identification information to the other terminal device based on the reception of the first request message, and
the second identification information indicates the request for the switching of the communication between the terminal devices from the direct communication using LTE to the infrastructure communication performed via the core network.

9. The terminal device according to claim 6,
wherein the terminal device is adapted to release a resource for the direct communication using LTE after the switching from the direct communication using LTE to the infrastructure communication performed via the core network is performed.

10. The terminal device according to claim 6,
wherein the terminal device is adapted to perform the infrastructure communication performed via the core network with the other terminal device by using an IP address used in the direct communication using LTE.

11. The terminal device according to claim 6,
wherein the terminal device is adapted to perform the infrastructure communication performed via the core network with the other terminal device by using a second IP address different from a first IP address used in the direct communication using LTE.

12-21. (canceled)
